(19) United States
(12) Patent Application Publication
(10) Pub. No.: US 2026/0254254 A1
(43) Pub. Date: Aug. 27, 2026

(54) CONSTANT MICRO POWER ENERGY SYSTEM (CMPES) DEVICE

(71) Applicant: Aziz Shakarzahi, Round Rock, TX (US)

(72) Inventor: Aziz Shakarzahi, Round Rock, TX (US)

(21) Appl. No.: 19/649,205

(22) Filed: Apr. 16, 2026

Related U.S. Application Data
(63) Continuation-in-part of application No. PCT/US2024/041725, filed on Aug. 9, 2024.
(63) Continuation-in-part of application No. 18/438,424, filed on Feb. 10, 2024, now Pat. No. 12,658,762.
Application No. 18/438,424 is a continuation-in-part of application No. 18/213,270, filed on Jun. 23, 2023, now abandoned.
(60) Provisional application No. 63/897,418, filed on Oct. 10, 2025.
(60) Provisional application No. 63/355,598, filed on Jun. 25, 2022.

(51) Int. Cl. H02J 3/46; H02K 7/00; H02K 7/116; H02P 9/02

(52) U.S. Cl. CPC H02J 3/46; H02K 7/003; H02K 7/116; H02P 9/02

(57) ABSTRACT

A constant micro power energy system includes a body including a base, a frame, and a top. A flask barrel is positioned within the frame. One or more motors operably mount to the top and operably connect to an electrical power input, each motor includes a shaft having a gear configured for rotation. A ring gear is operatively coupled to the flask barrel and is engaged with each motor gear. One or more disc flux generators is positioned inside the flask barrel and is configured to rotate with the flask barrel. The motor(s) drives rotation of the flask barrel and the disc flux generator(s) up to a predetermined consistent rotational speed which generates continuous and simultaneous electrical output. The flux generator(s), in turn, provides the electrical output to an electrical panel system. The sum of electrical output is greater than a sum of electrical input powering the motors.

### RELATED APPLICATIONS AND CLAIM FOR PRIORITY

This application is a continuation-in-part of U.S. Application Serial No. 18/438,424 filed February 10, 2024 which is a continuation-in-part of U.S. Application Serial No. 18/213,270, filed June 23, 2023; which claims the benefit of U.S. Provisional Application No. 63/355,598, filed June 25, 2022; and this application is a continuation in part of PCT/US2024/41725 filed August 9, 2024; this application also claims the benefit of U.S. Provisional Application No. 63/897,418, filed October 10, 2025; all of which are incorporated herein in their entirety and referenced thereto.

### TECHNICAL FIELD

The present disclosure relates to cylindrical disc flux generators, and in particular, relates to a constant micro power energy system (CMPES) device designed to harness sustainable energy sources and generate power while maintaining zero carbon emissions.

### DESCRIPTION OF THE RELATED ART

The depletion of non-renewable energy sources, including coal and oil, has led to a global energy crisis. The global energy crisis has prompted a growing need for alternative and renewable energy sources to meet the increasing demand for power. Among the renewable energy sources, wind power has emerged as a promising solution. Wind turbines have become a prevalent technology for harnessing wind energy and converting it into electricity. However, despite their widespread use, existing wind turbines face various limitations that hinder their optimal performance and efficiency. Addressing these limitations is crucial to fully unlock the potential of wind power and ensure a sustainable energy future. Traditional wind turbines face a significant drawback in their performance, particularly in low wind conditions. The wind turbines have a minimum wind speed requirement to initiate electricity generation, rendering them ineffective when wind speeds are insufficient. As a result, consistent and reliable electricity generation from the wind turbines becomes challenging, especially in regions with lower wind speeds.

In addition, devices that utilize renewable energy, hereinafter referred as renewable energy devices, often grapple with sustainability and storage limitations. For instance, solar and wind power heavily rely on favorable weather conditions, and the captured energy needs to be stored for future use. Unfortunately, unfavorable weather conditions can disrupt power generation, and the cost of storage batteries can be prohibitively high. These constraints pose obstacles to the widespread adoption of renewable energy sources, hampering progress toward a more sustainable future.

Some of the renewable energy systems have been disclosed in the past. An example is disclosed in a United States Patent No. 5,384,489, entitled “Wind-powered electricity generating system including wind energy storage” (“the ‘489 Patent”). The ‘489 Patent discloses a wind-powered electricity generating system including a wind energy storage and recovery device. The wind energy storage and recovery device include a wind-powered electricity generator (not necessarily a system of the disclosure), a heater operable with electricity from the generator, thermal fluid heated by the heater, a tank to store the heated fluid, and a stored heat energy extractor. In addition to the storage and recovery device, the system of the disclosure also includes blades mounted to rotate a shaft of a wind-powered generator in response to the wind to create electricity, and switch mechanism actuatable in response to the amount of electricity created by the generator for applying electricity to the heater. In another aspect the disclosure relates to a method for storing wind energy.

Another example is disclosed in a European Publication No. 1,577,549, entitled “Apparatus for storing thermal energy and generating electricity” (“the ‘549 Publication”). The ‘549 Publication discloses a system for storing thermal energy, comprising a heat storage device with a heat storage medium operating between a lower and a higher temperature level, a first heat generator comprising an electrical resistor inside the heat storage device for heating the heat storage medium with electrical power, a first heat transfer device for transferring thermal energy from the heat storage device to a thermodynamic machine for generating electricity,

Traditional wind turbines and other renewable energy devices with storage systems suffer from a notable limitation, i.e., limited power output. Traditional wind turbines usually employ a configuration of two or multiple blades connected to a central shaft and generator. The design constraint restricts the potential energy generation capacity of the turbine and poses challenges in maximizing the efficient capture of wind energy. As a result, there is a need for innovative solutions that can overcome these limitations and enable higher power output while optimizing the utilization of wind energy resources.

Moreover, traditional wind turbines and most renewable energy systems are often burdened with high manufacturing, installation, and maintenance costs. Traditional wind turbines and renewable energy systems demand specialized equipment and skilled labor, rendering them costly and inaccessible for numerous communities, particularly in developing countries. The expense associated with acquiring and maintaining renewable energy solutions hampers their widespread adoption and impedes progress towards achieving sustainable and affordable energy access for all.

Consequently, there is a need for innovative approaches that address these cost-related challenges and facilitate the deployment of renewable energy technologies on a broader scale. To overcome these limitations, there exists a demand for a groundbreaking electric energy generator that can effectively produce electricity across various conditions, exhibit a high-power output, and offer cost-effective manufacturing, installation, and maintenance processes.

### SUMMARY

Present in accordance with the present disclosure is a device for a constant micro power energy system (CMPES) which includes a main body structure including a base plate, a frame extending from the base plate, and a top plate positioned at the top of the frame. A flask barrel is positioned within the frame and one or more motors is operably mounted to the top plate, the one or more motors operably connected to an electrical power input for powering each of the one or more motors, each motor of the one or more motors including a motor shaft having a gear configured for rotation with the motor shaft. A ring gear is operatively coupled to the flask barrel and is engaged with each gear of each of the one or more motor shafts. One or more disc flux generators is positioned inside the flask barrel and is configured to rotate with the flask barrel. Each shaft of the one or more motors is configured to rotate each respective gear upon actuation of each of the one or more motors, which, in turn, is configured to rotate the ring gear and drive rotation of the flask barrel and the one or more disc flux generators up to a predetermined consistent rotational speed. Rotation of the flask barrel and the one or more disc flux generators at a predetermined consistent rotational speed generates continuous and simultaneous alternating current (AC) and direct current (DC) electrical power output and the one or more disc flux generators, in turn, provide the electrical power output to electrical panel systems adapted to connect to the CMPES device. A sum of electrical power output from the rotation of the disc flux generators is greater than a sum of electrical power input powering the one or more motors.

In aspects in accordance with the present disclosure, the rotation of the flask barrel and the one or more flux generators is also configured to provide electrical power to the one or more motors once the one or more disc flux generators reach the predetermined rotational speed.

In aspects in accordance with the present disclosure, the predetermined consistent rotational speed and the predetermined rotational speed are the same.

In aspects in accordance with the present disclosure, the sum of the electrical power output of the one or more motors is in the range of about 0.75 kW to about 30 kW.

In aspects in accordance with the present disclosure, each of the one or more motors is configured to deliver a power output in the range of about 0.75 kW to about 5 kW. In other aspects in accordance with the present disclosure, two or more motors of the one or more motors are configured to be in an active state and remaining motors of the one or more motors are configured to be in a resting state, and wherein the two or more motors of the one or more motors in the active state deliver a combined electrical power output is in the range of about 1.5 kW to about 30 kW to rotate the flask barrel and the one or more disc flux generators at a consistent rotation.

In aspects in accordance with the present disclosure, the flask barrel rotates at a predetermined consistent rotational speed of about 250 rotations per minute (rpm).

In aspects in accordance with the present disclosure, the one or more disc flux generators are stacked inside the flask barrel such that a larger-sized disc flux generator of the one or more disc flux generators is positioned at the bottom of the flask barrel and is configured to deliver a higher kilowatt output.

In aspects in accordance with the present disclosure, the position of the one or more disc flux generators are adjustable within the flask barrel.

In aspects in accordance with the present disclosure, wherein the CMPES device further comprises decorative panels, wherein said decorative panels encapsulate the bottom side of said main body structure.

In aspects in accordance with the present disclosure, a cover cap inserts onto said flask barrel and facilitates convenient opening and closing.

In aspects in accordance with the present disclosure, the one or more disc generators are arranged in combination and each disc generator is configured to produce an electrical power output in the range of about 5 kW-100 kW.

In aspects in accordance with the present disclosure, the CMPES device further comprises a protective fence and distance rings, wherein said protective fence positions on said distance rings to provide a safe distance between a motor drive gear of each of said motor and said ring gear in order to prevent accidental contact during operation.

In aspects in accordance with the present disclosure, the CMPES device further comprises a control system configured to monitor and regulate the electrical power output of the one or more disc flux generators to optimize energy output of the one or more disc flux generators.

In aspects in accordance with the present disclosure, the CMPES device further comprises a hand crank handle system operably affixed to the flask barrel and configured to manual initiate rotation of the flask barrel and generation of electrical power output from the one or more disc flux generators.

In other aspects the present disclosure also includes a constant micro power energy system (CMPES) including an electrical power source providing an electrical power input. A CMPES device is included having one or more motors operably coupled to the electrical power source and configured to receive the electrical power input. A main body structure is configured to operably support the one or more motors, each motor of the one or more motors including a motor shaft having a gear configured for rotation with the motor shaft. A flask barrel is positioned within the main body structure, the flask barrel including a ring gear operatively coupled to the flask barrel and configured to engage each gear of each of the one or more motor shafts. One or more disc flux generators is positioned inside the flask barrel and configured to rotate with the flask barrel. Each shaft of the one or more motors is configured to rotate each respective gear upon actuation of each of the one or more motors, which, in turn, is configured to rotate the ring gear and drive rotation of the flask barrel and the one or more disc flux generators up to a predetermined consistent rotational speed. Rotation of the flask barrel and the one or more disc flux generators at a predetermined consistent rotational speed generates continuous and simultaneous alternating current (AC) and direct current (DC) electrical power output. The one or more disc flux generators, in turn, provide the electrical power output to an electrical panel system, wherein a sum of the electrical power output from the rotation of the disc flux generators is greater than a sum of the electrical power input powering the one or more motors.

In aspects in accordance with the present disclosure, the rotation of the flask barrel and the one or more flux generators is also configured to provide electrical power to the one or more motors once the one or more disc flux generators reach the predetermined rotational speed.

In aspects in accordance with the present disclosure, the sum of the electrical power output of the one or more motors is in the range of about 0.75 kW to about 30 kW and each of the one or more motors is configured to deliver a power output in the range of about 0.75 kW to about 5 kW.

In aspects in accordance with the present disclosure, two or more motors of the one or more motors are configured to be in an active state and remaining motors of the one or more motors are configured to be in a resting state, and wherein the two or more motors of the one or more motors in the active state deliver a combined electrical power output is in the range of about 1.5 kW to about 30 kW to rotate the flask barrel and the one or more disc flux generators at a consistent rotation.

In aspects in accordance with the present disclosure, the flask barrel rotates at a predetermined consistent rotational speed of about 250 rotations per minute (rpm).

It is an object of the present disclosure to provide a constant micro power energy system (CMPES) device designed to harness sustainable energy sources and generate power while maintaining zero carbon emissions and that avoids the drawback of known wind turbines and other renewable energy devices.

It is another object of the present disclosure to provide an efficient and reliable solution for electricity generation that surpasses the constraints of existing technologies and also facilitates the widespread adoption of sustainable power sources.

In order to achieve one or more objects, the present disclosure provides a constant micro power energy system (CMPES) device to harness sustainable energy sources and generate power. The CMPES device includes a main body structure having a base plate, a frame extending from the base plate, and a top plate positioned at the top of the frame. The CMPES device includes a flask barrel positioned in the frame and motors positioned on the top plate. The CMPES device includes a ring gear connecting the flask barrel and a motor shaft of each motor. The ring gear 70 has 150 helically shaped teeth, with an outer diameter of 803.2 mm, and an inner diameter of 596 mm. The ring gear provides speed reduction and torque increase. The CMPES device includes disc generators positioned inside the flask barrel. In one example, five disc generators are inserted inside the flask barrel. The disc generators are constructed from high-quality aluminum parts. The motors supply power to drive the flask barrel to rotate constantly at a predetermined speed in order to generate continuous electrical power output. The motors facilitate direct transmission to the disc generators in order to provide the electrical power output to panel systems connected to the CMPES device.

In one aspect, the motors include six-geared motors positioned on the top plate. Each motor is directly splined to a helical gear having 27 teeth with an outer diameter of 149.7 mm. Each motor is configured to deliver a power output of .75kW to 1.1 kW. In one implementation, two or more motors (preferably three motors out of six motors) are configured to be in an active state and remaining motors are configured to be in a resting state. The motors in the active state are configured to deliver a combined power output of 2.25 kW to rotate the flask barrel constantly. In the present disclosure, three of the six motors are switched selectively and operated to generate a combined power output of 2.25 kW to rotate the flask barrel constantly. Each of three motors has a minimum power output of 0.75 kW per motor and three motors are used to achieve the flask barrel speed of 250 rotations per minute. Here, each motor presents a Nominal torque of one motor is 4.95 (Newton meter) Nm while its max (peak) torque is 12.7 Nm. In one example, a motor with a power output of 1.1 kW is utilized at 83% capacity during the initial acceleration stage and 32% capacity during nominal operation.

In another aspect of the present disclosure, the CMPES device includes a perforated sheet metal protective fence securely placed on twelve distance rings, ensuring a safe distance from the motor drive gear and the machine ring gear. Further, the CMPES device includes two half-circle sheet metal decorative panels encapsulating the bottom side of the main body structure. Furthermore, the CMPES device includes a cover cap made from PA6 plastic, designed for easy insertion onto the main barrel flask, featuring a flange for convenient opening and closing.

In yet another aspect of the present disclosure, the CMPES device can be used with a hand crank system for turning the disc flux generator to initiate power for the cylinder motors.

In yet another aspect of the present disclosure, a single CMPES device can be used for simultaneous AC and DC variant output by One CMPES system device. Here, the AC and DC outputs are provided distinct from one another simultaneously. Such a CMPES device can be used in transportation, aviation and marine vehicles and vessel to ensure seamless and distinct AC and DC outputs.

In addition. The CMPES device allows to adjust discs to be switched OFF and switched ON without changing the functionality of rotating cylinder. This helps to achieve refinements to ensure a smoother rotation of desired discs. Further, the CMPES device presents an open section with the base. The open section allows the user to insert the flask barrel and disc flux generators thereby providing convenient access for maintenance procedures and disc insertion. Additionally, the unique CMPES device design allows for ambient air flow within the system. The CMPES device design can be optimized for improving air flow efficiency.

In one advantageous feature of the present disclosure, the CMPES device presents a compact and efficient solution for harnessing electric energy and generating electricity. By incorporating disc flux generators, the gears, the motors, and optimized barrel shapes, the CMPES device ensures consistent power output in desired kilowatts. The CMPES device presents high power output, portability, low maintenance requirements, environmental friendliness, scalability, and cost-effectiveness. With a capacity to generate up to 100 kW or more, the CMPES device can be implemented in various settings, from residential to commercial and industrial.

In another advantageous feature of the present disclosure, the compact and lightweight design of the CMPES device enables easy transportation and installation, making it particularly suitable for remote areas or temporary setups where power is in high demand. Its minimal moving parts reduce maintenance needs, ensuring exceptional durability and longevity. By harnessing electric energy, the CMPES device contributes to the reduction of greenhouse gas emissions and dependence on fossil fuels, providing a clean and sustainable source of electricity. The CMPES device operates with minimal noise. As such, the CMPES device is suitable for residential areas, and its modular design allows effortless scalability to meet specific power requirements. Its efficient operation, combined with low maintenance needs and the ability to generate power in various conditions establishes the CMPES device as a cost-effective solution for renewable energy generation.

The present disclosure also relates to a method for generating energy, including: rotating a flask barrel and one or more flux generators using electrical power input from one or more motors to reach a predetermined consistent rotational speed such that the rotation of the flask barrel and the one or more disc flux generators at the predetermined consistent rotational speed generates continuous and simultaneous alternating current (AC) and direct current (DC) electrical power output; and offloading the electrical power output to one or more electrical panel systems, wherein a sum of electrical power output from the rotation of the disc flux generators is greater than a sum of electrical power input powering the one or more motors.

In aspects in accordance with the present disclosure, the method further includes providing electrical power to the one or more motors once the one or more disc flux generators reach the predetermined consistent rotational speed.

In aspects in accordance with the present disclosure, the predetermined consistent rotational speed and the predetermined rotational speed are the same.

In aspects in accordance with the present disclosure, wherein the one or more motors is configured to deliver a power output in the range of about 0.75 kW to about 5 kW.

In aspects in accordance with the present disclosure, the method further includes activating two or more of the one or more motors to be in an active state and deactivating two or more of the one or more motors to be in a resting state.

In aspects in accordance with the present disclosure, the flask barrel rotates at a predetermined consistent rotational speed of about 250 rotations per minute (rpm).

In aspects in accordance with the present disclosure, the method further includes adjusting the one or more disc flux generators within the flask barrel.

In aspects in accordance with the present disclosure, the method further includes arranging the one or more disc flux generators in combination and each disc flux generator is configured to produce an electrical power output in the range of about 5 kW-100 kW.

In aspects in accordance with the present disclosure, the method further includes monitoring the electrical power output of the one or more disc flux generators with a control system configured to optimize energy output of the one or more disc flux generators.

In aspects in accordance with the present disclosure, the method further includes providing a hand crank handle system operably affixed to the flask barrel and configured to manual initiate rotation of the flask barrel and generation of electrical power output from the one or more disc flux generators.

The features and advantages of the disclosure here will become more apparent in light of the following detailed description of selected embodiments, as illustrated in the accompanying FIGURES. As will be realized, the disclosure disclosed is capable of modifications in various respects, all without departing from the scope of the disclosure. Accordingly, the drawings and the description are to be regarded as illustrative in nature.

### BRIEF DESCRIPTION OF THEDRAWINGS

The present disclosure will now be described in detail with reference to the drawings, which are provided as illustrative examples of the disclosure so as to enable those skilled in the art to practice the disclosure. Notably, the FIGURES and examples are not meant to limit the scope of the present disclosure to a single embodiment, but other embodiments are possible by way of interchange of some or all of the described or illustrated elements and, further, wherein:

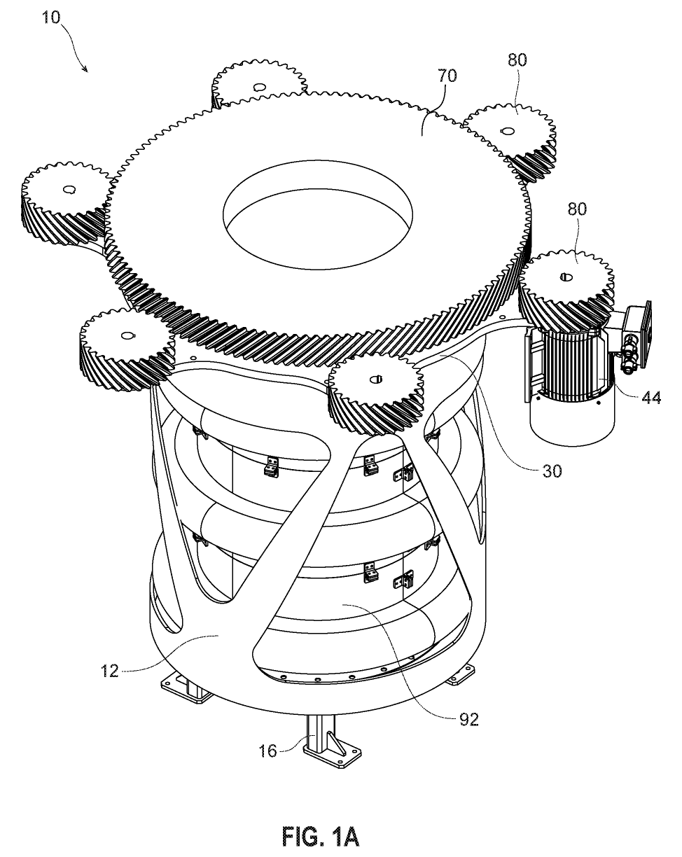

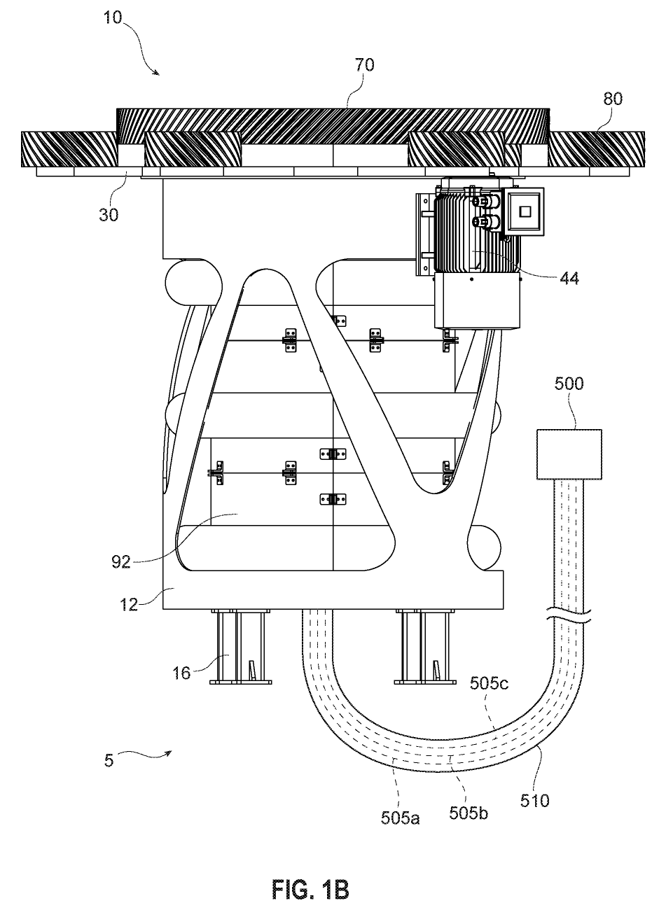

FIGS. 1A - 1B illustrate a perspective view and a side view, respectively, of view of a constant micro power energy system (CMPES) and CMPES device, in accordance with one embodiment of the present disclosure;

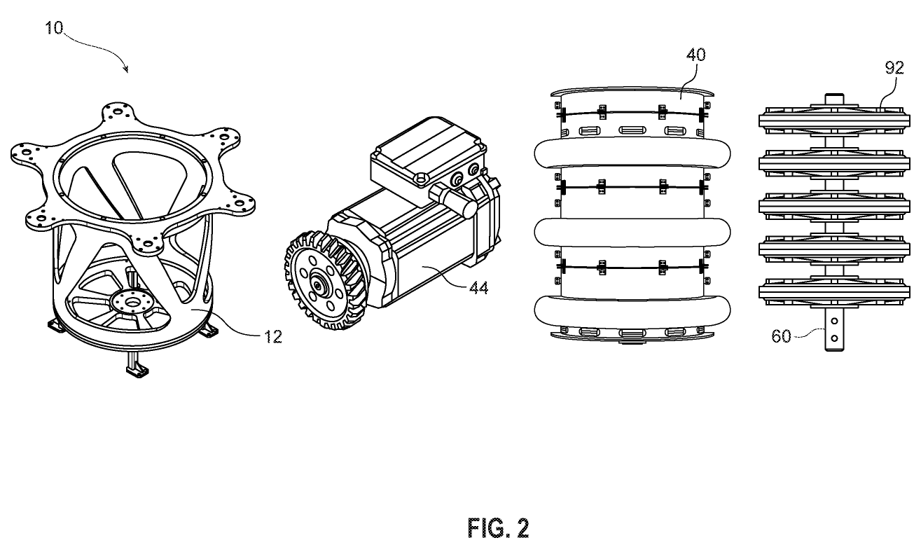

FIG. 2 illustrates a disassembled view of the CMPES device of FIGS. 1A and 1B;

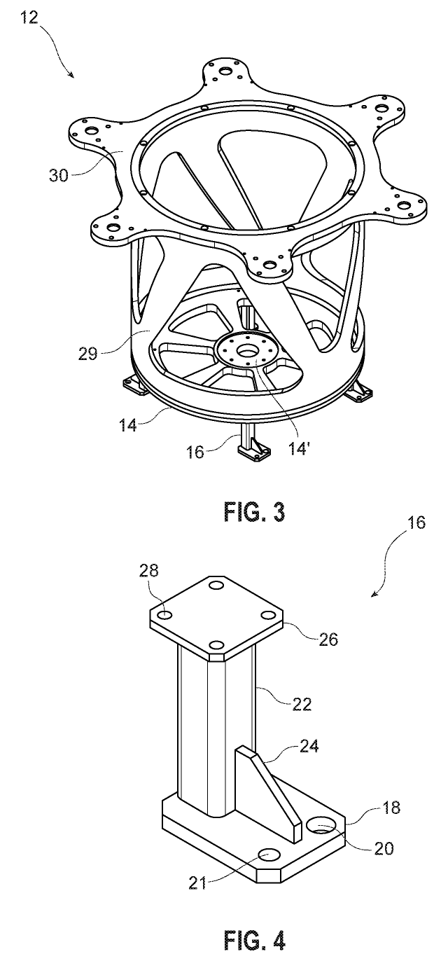

FIG. 3 illustrates a perspective view of main body structure, in accordance with the CMPES device of FIGS. 1A and 1B;

FIG. 4 illustrates a perspective view of leg of the CMPES device, in accordance with the CMPES device of FIGS. 1A and 1B;

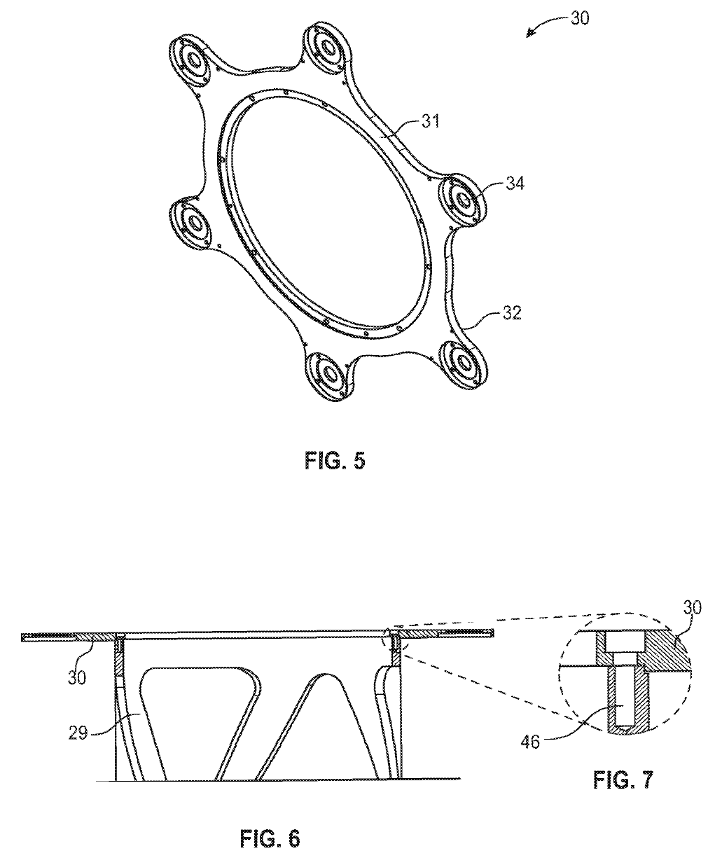

FIG. 5 illustrates a bottom perspective view of top plate, in accordance with the CMPES device of FIGS. 1A and 1B;

FIG. 6 illustrates dowel pins used to press-fit the top plate to a frame, in accordance with the CMPES device of FIGS. 1A and 1B;

FIG. 7 illustrates an enlarged view of dowel pins press-fitted into position between a top plate and a main welded structure of the CMPES device of FIGS. 1A and 1B;

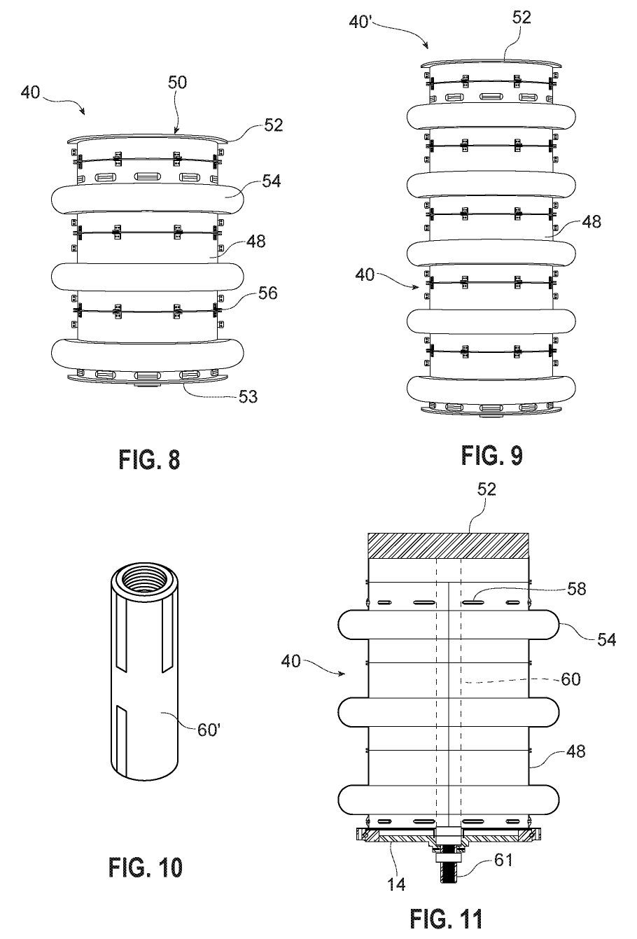

FIG. 8 illustrates a perspective view of flask barrel, in accordance with the CMPES device of FIGS. 1A and 1B;

FIG. 9 illustrates a cross-sectional view of a five (5) ring flask barrel, configured to incorporate five (5) flux generators in accordance with another embodiment of the present disclosure;

FIG. 10 illustrates a perspective view of a shaft coupling, in accordance with the CMPES device of FIGS. 1A and 1B;

FIG. 11 illustrates a cross-sectional view of the flask barrel having a shaft, in accordance with the CMPES device of FIGS. 1A and 1B;

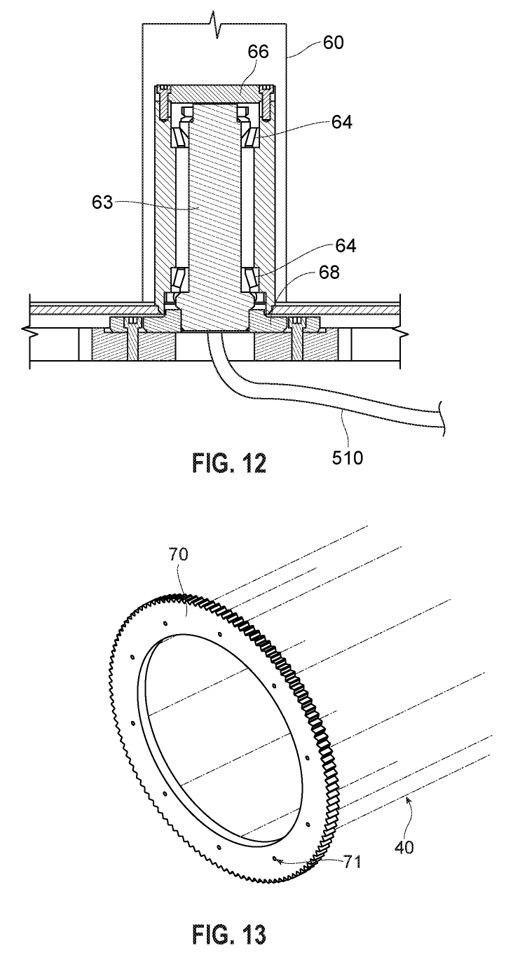

FIG. 12 illustrates an enlarged view of a support rod and bearings for use with the flask barrel of the CMPES device of FIGS. 1A and 1B;

FIG. 13 illustrates a perspective view of a ring gear in accordance with the CMPES device of FIGS. 1A and 1B;

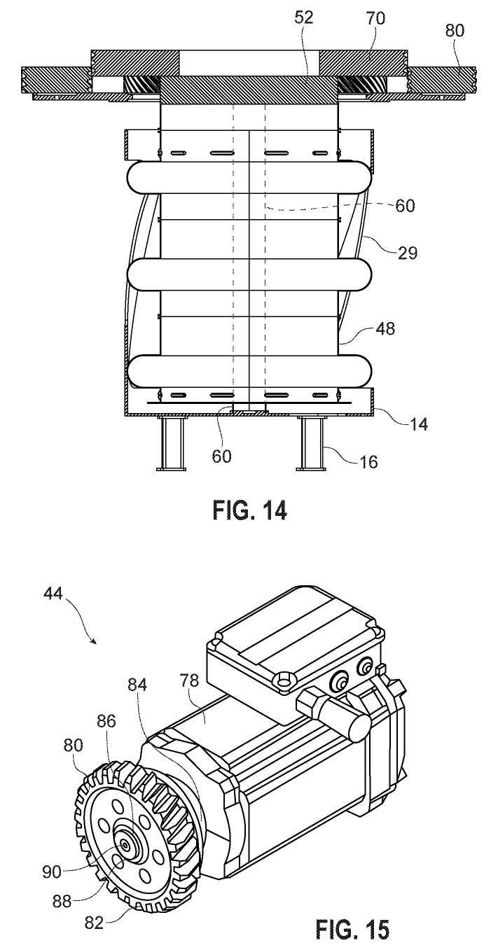

FIG. 14 illustrates a cross-sectional view of the flask barrel having the ring gear assembled to the shaft, in accordance with the CMPES device of FIGS. 1A and 1B;

FIGS. 15 - 16 illustrate a perspective view and a cross-sectional view, respectively, of a motor for use with the CMPES device of FIGS. 1A and 1B;

FIGS. 17 - 18 illustrate perspective views of a plurality of disc flux generators, in accordance with the CMPES device of FIGS. 1A and 1B;

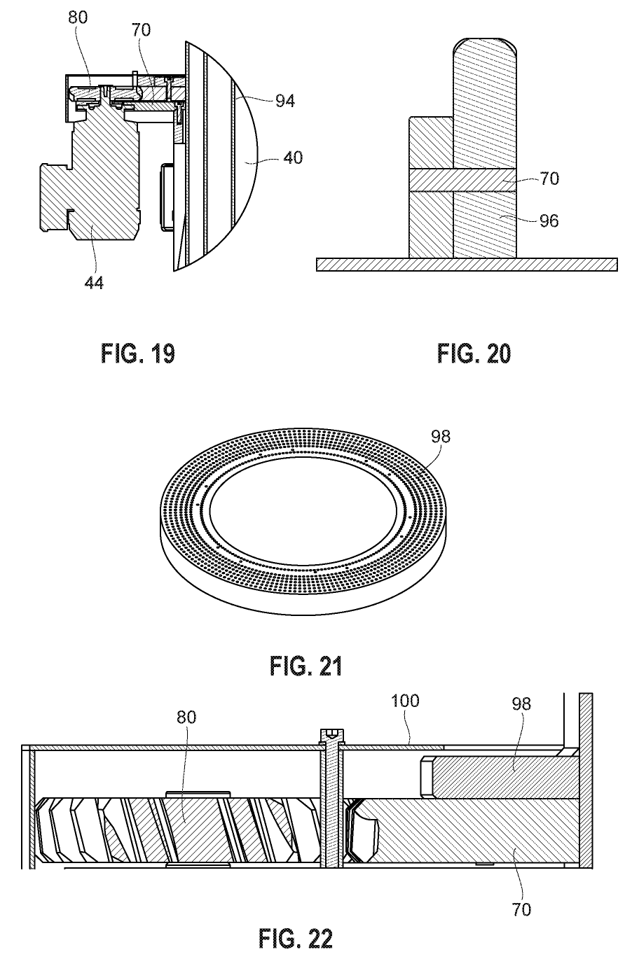

FIG. 19 illustrates a cross-sectional view of the one of the motors for use with the CMPES device, in accordance with one embodiment of the present disclosure;

FIG. 20 illustrates dowel pins secured to the ring gear, in accordance with the CMPES device of FIGS. 1A and 1B;

FIG. 21 illustrates a protective fence, in accordance with the CMPES device of FIGS. 1A and 1B;

FIG. 22 illustrates the protective fence strategically positioned using twelve distance rings, in accordance with the CMPES device of FIGS. 1A and 1B;

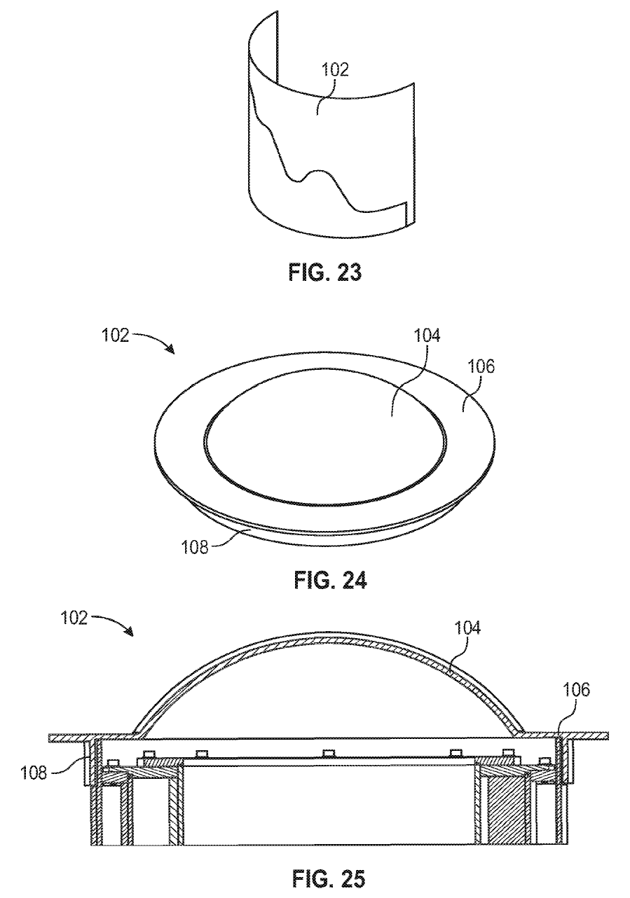

FIG. 23 illustrates an enlarged, perspective view of decorative panel, for use with the CMPES device of FIGS. 1A and 1B;

FIGS. 24 - 25 illustrate a perspective view and a cross-sectional view, respectively of a cover cap, for use with the CMPES device of FIGS. 1A and 1B;

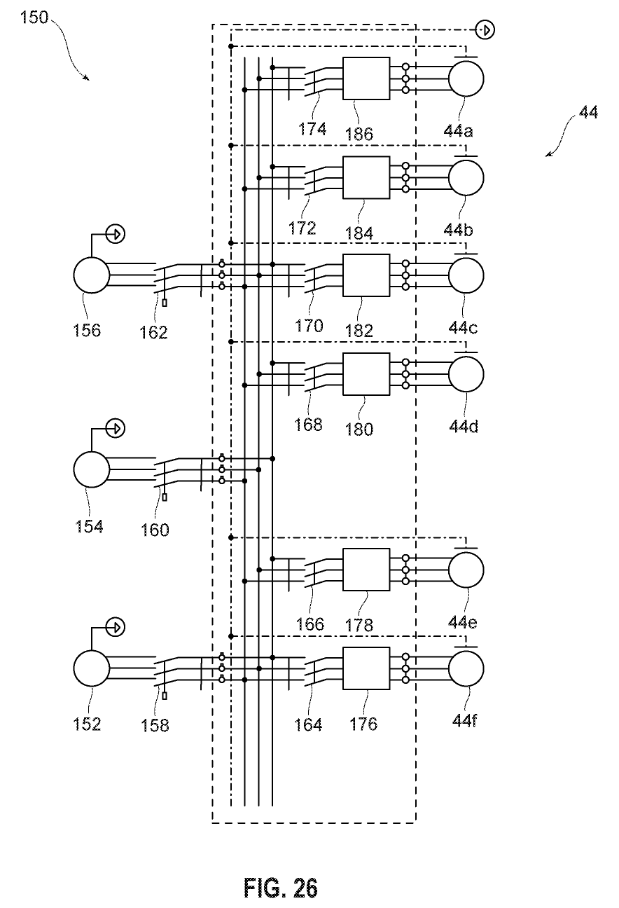

FIG. 26 illustrates a circuit diagram, in accordance with the CMPES system and CMPES device of FIGS. 1A and 1B;

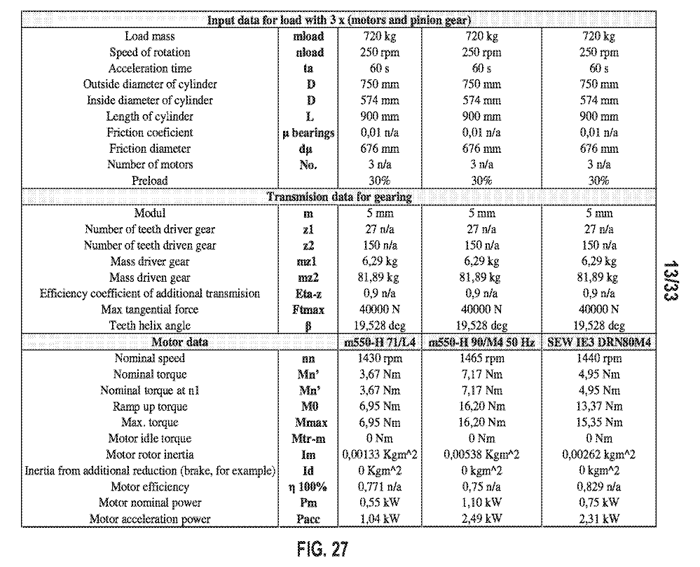

FIGS. 27 - 28 illustrate tables presenting initiation calculations for the selection of one or more motors, in accordance with the CMPES system and CMPES device of FIGS. 1A and 1B;

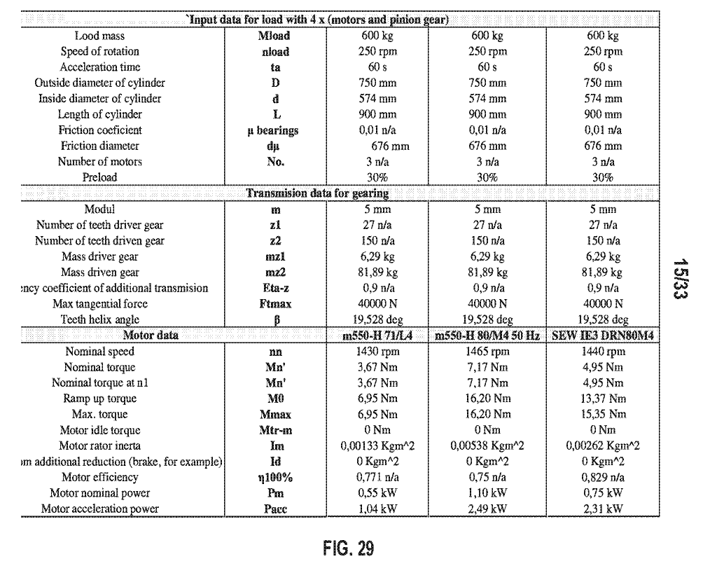

FIGS. 29 - 30 illustrate tables showing the results obtained based on the initiation calculations for motor selection, in accordance with the CMPES system and CMPES device of FIGS. 1A and 1B;

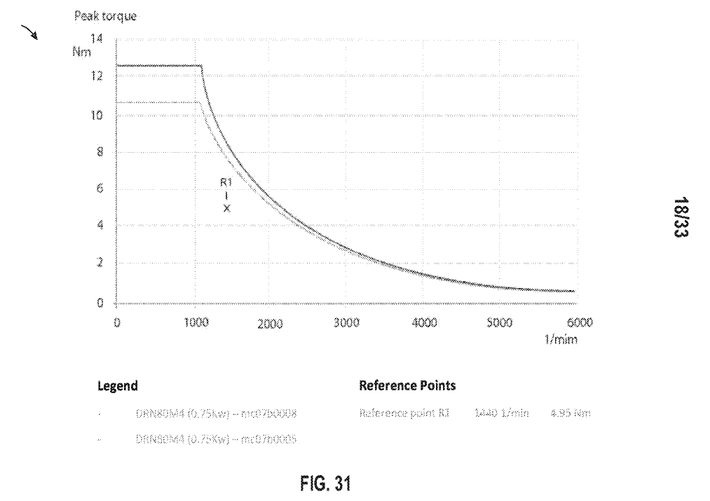

FIGS. 31 - 32 illustrate various motor characteristics of the one or more motors configured for use with the CMPES system and CMPES device of FIGS. 1A and 1B;

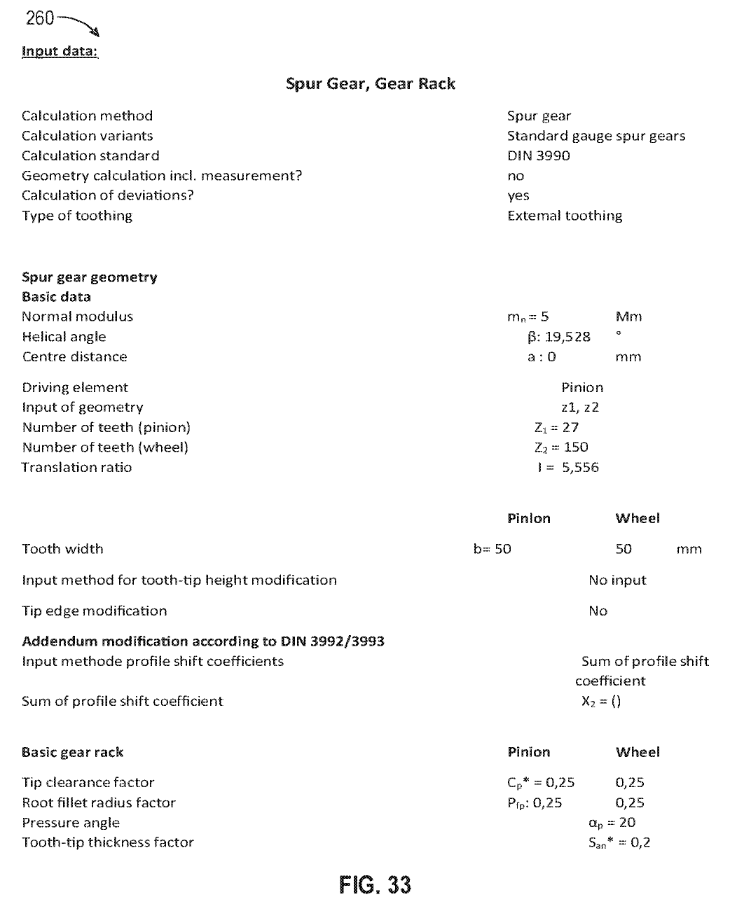

FIG. 33 illustrates a table showing input data for various gear profiles for use with gears configured for use with the CMPES system and CMPES device of FIGS. 1A and 1B;

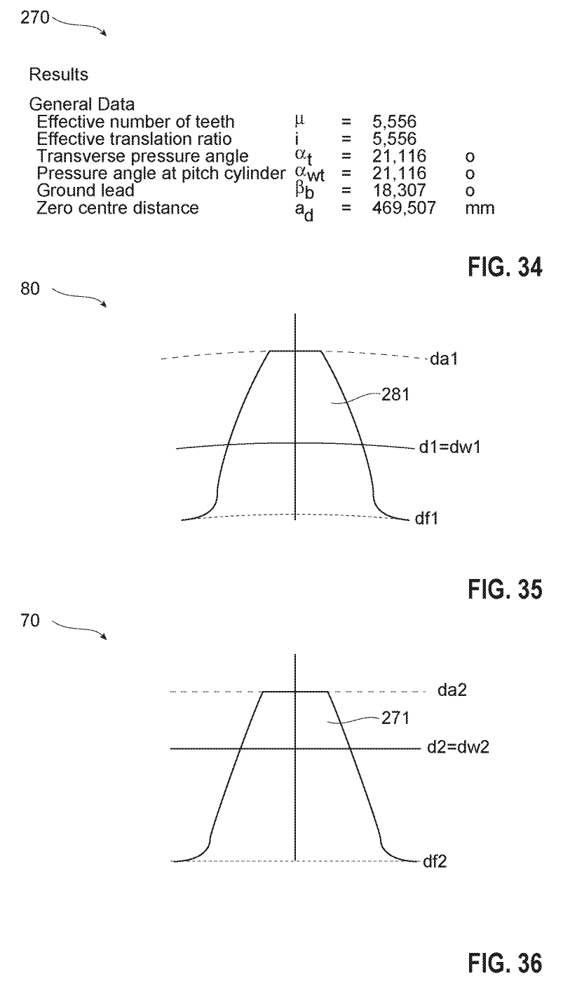

FIG. 34 illustrates output calculations and design of the gears for use with the CMPES system and CMPES device of FIGS. 1A and 1B;

FIGS. 35 - 42 illustrate various gear profiles, in accordance for use with the CMPES system and CMPES device of FIGS. 1A and 1B;

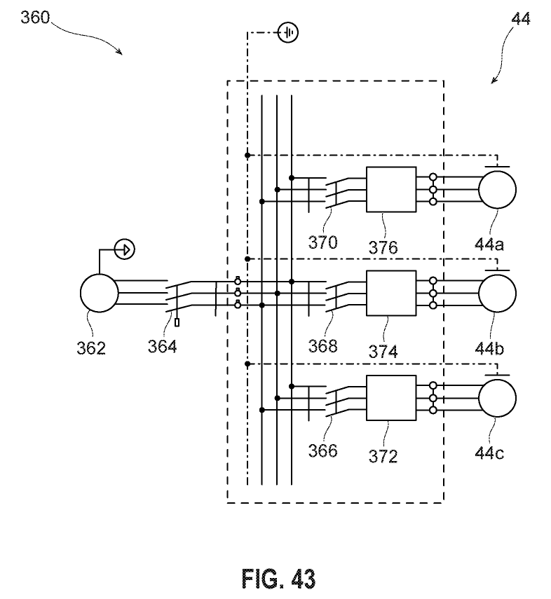

FIG. 43 illustrates circuit diagram, in accordance with another embodiment of the present disclosure;

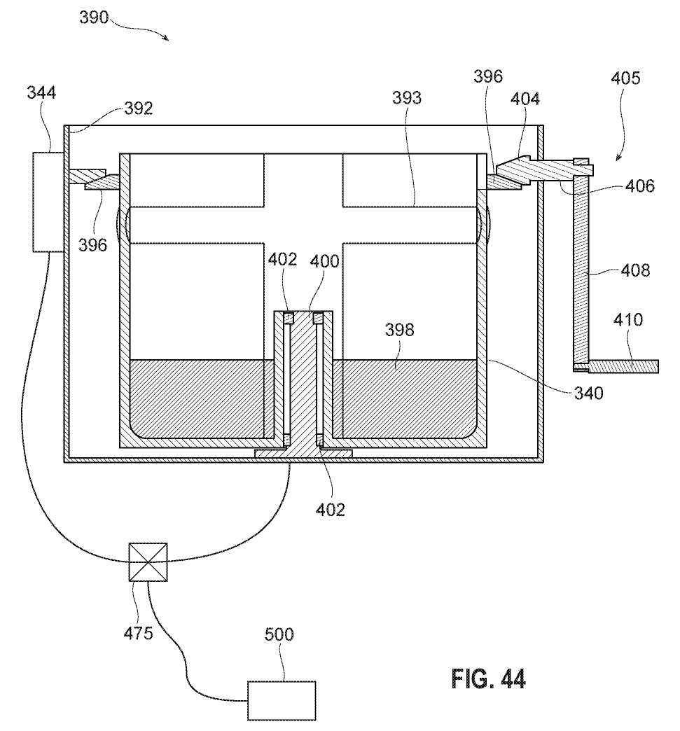

FIG. 44 illustrates a cross-sectional view of a CMPES device utilizing a hand crank handle system, in accordance with another embodiment of the present disclosure;

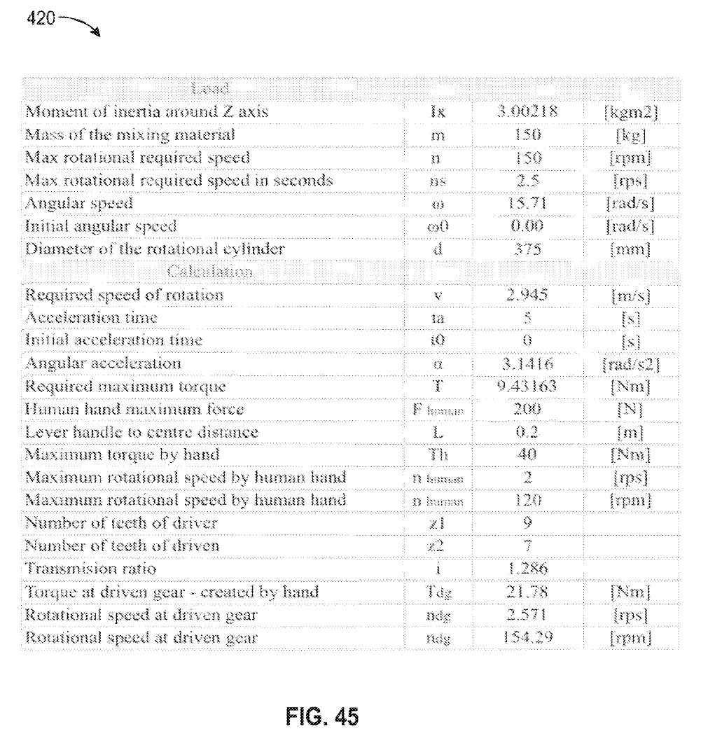

FIG. 45 illustrates a table showing gears and cylinder sizes for use with the CMPES system and CMPES device of the present disclosure; and

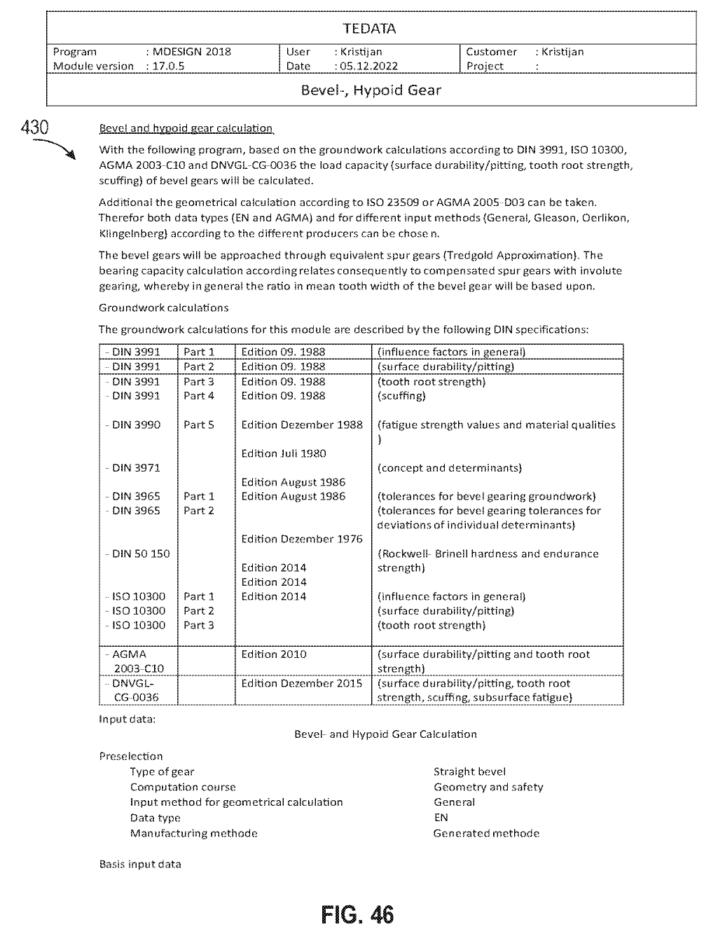

FIGS. 46 - 52 illustrate various pinion and wheel bevel gear (bevel and hypoid gear for 5 kW cylinder barrel) calculations for use with the CMPES system and CMPES device of the present disclosure.

### DETAILED DESCRIPTION

The following detailed description set forth below in connection with the appended drawings is intended as a description of exemplary embodiments in which the presently disclosed disclosure may be practiced. The detailed description includes specific details for providing a thorough understanding of the presently disclosed CMPES device. However, it will be apparent to those skilled in the art that the presently disclosed disclosure may be practiced without these specific details. In some instances, well-known structures and devices are shown in functional or conceptual diagram form in order to avoid obscuring the concepts of the presently disclosed CMPES device.

In the present specification, an embodiment showing a singular component should not be considered limiting. Rather, the disclosure encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present disclosure encompasses present and future known equivalents to the known components referred to herein by way of illustration.

Although the present disclosure provides a description of a CMPES device, it is to be further understood that numerous changes may arise in the details of the embodiments of the CMPES device. It is contemplated that all such changes and additional embodiments are within the spirit and true scope of this disclosure.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure.

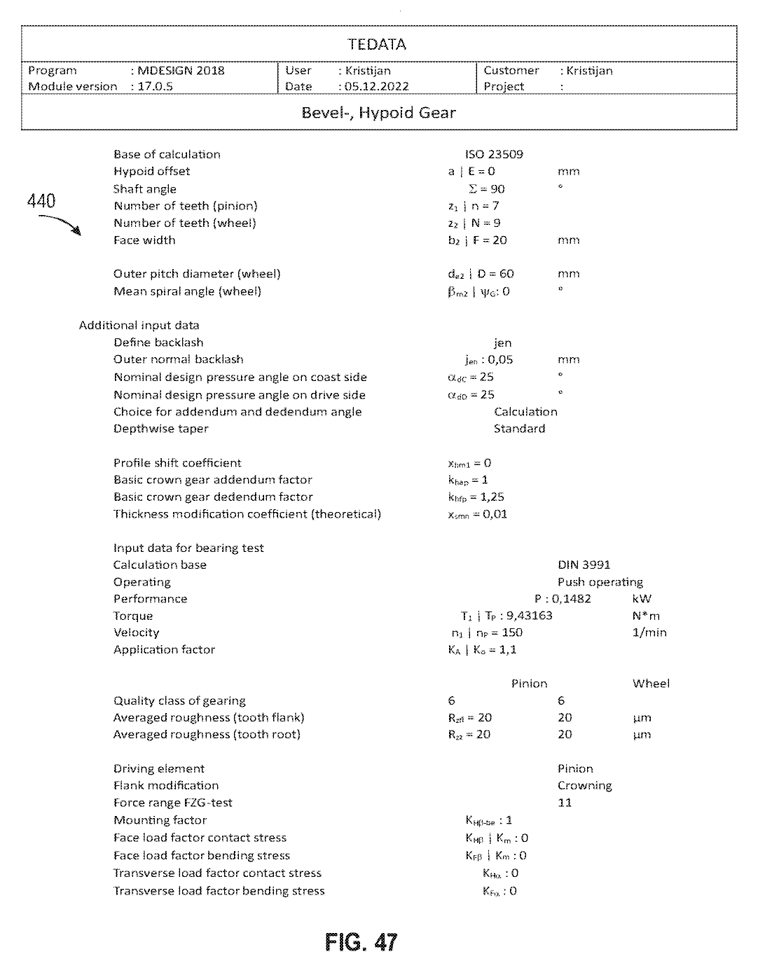

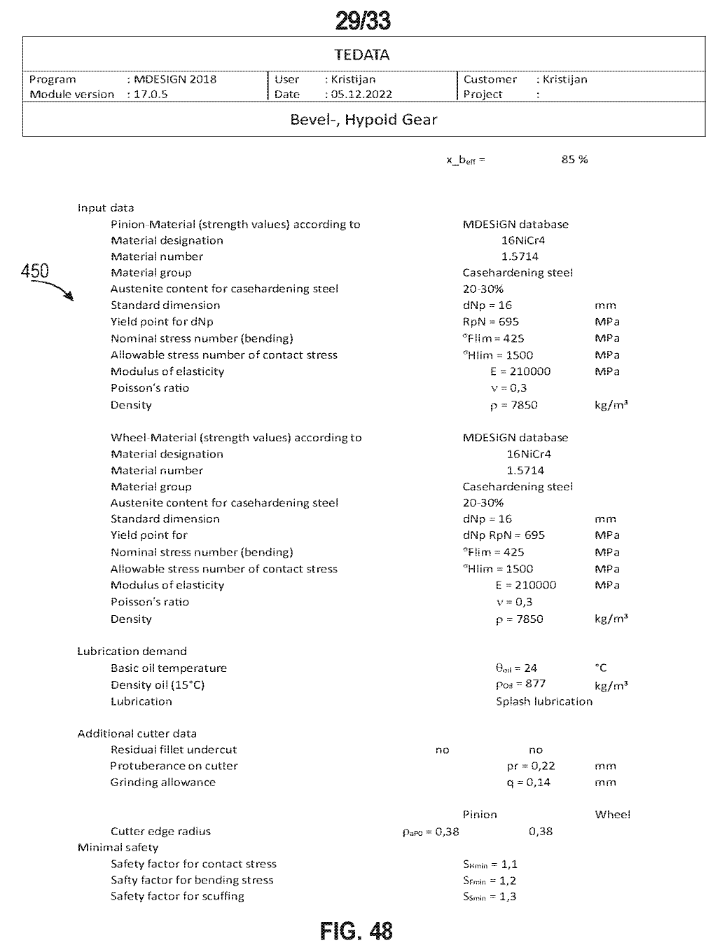

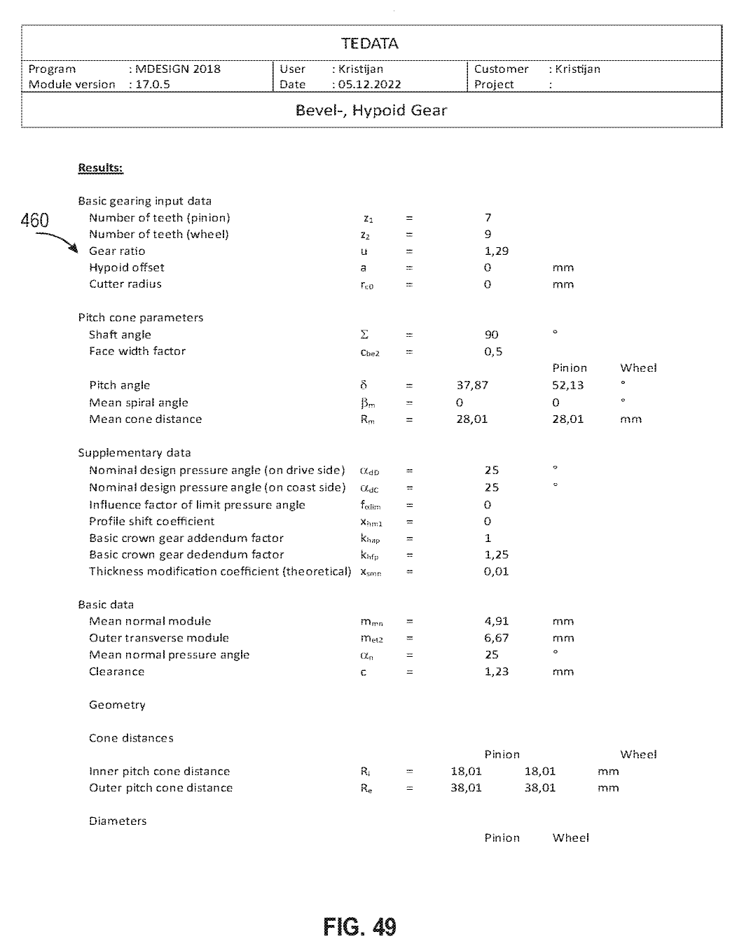

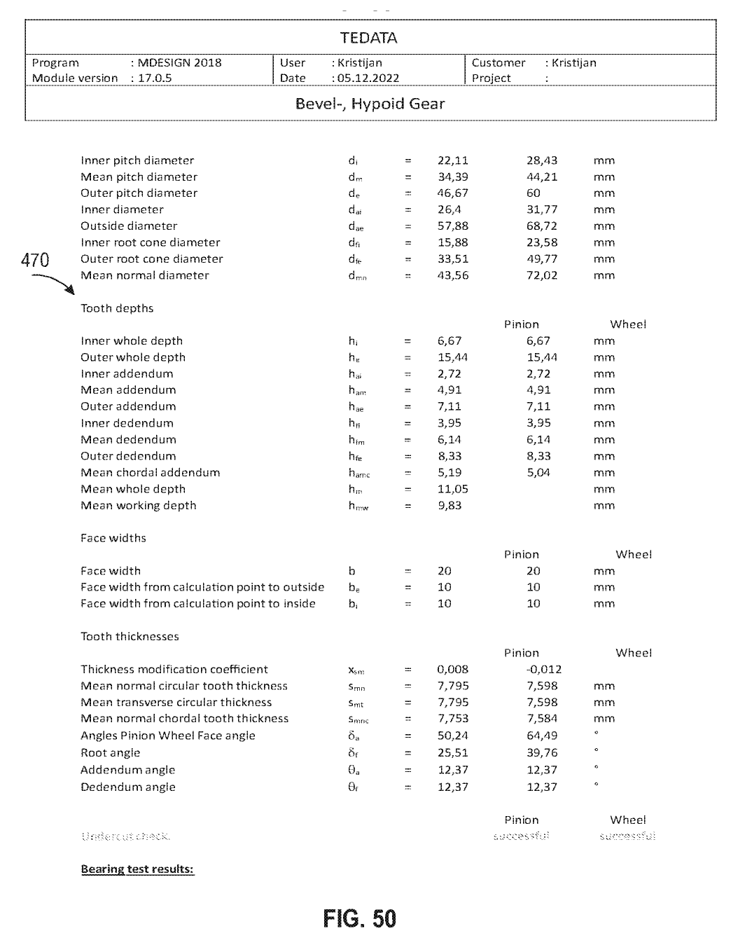

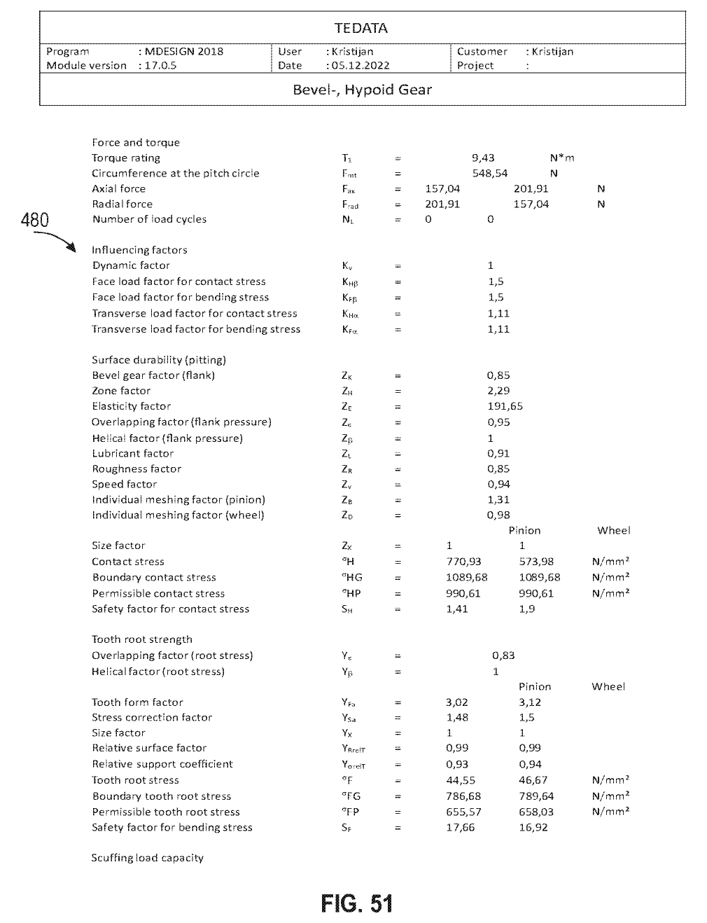

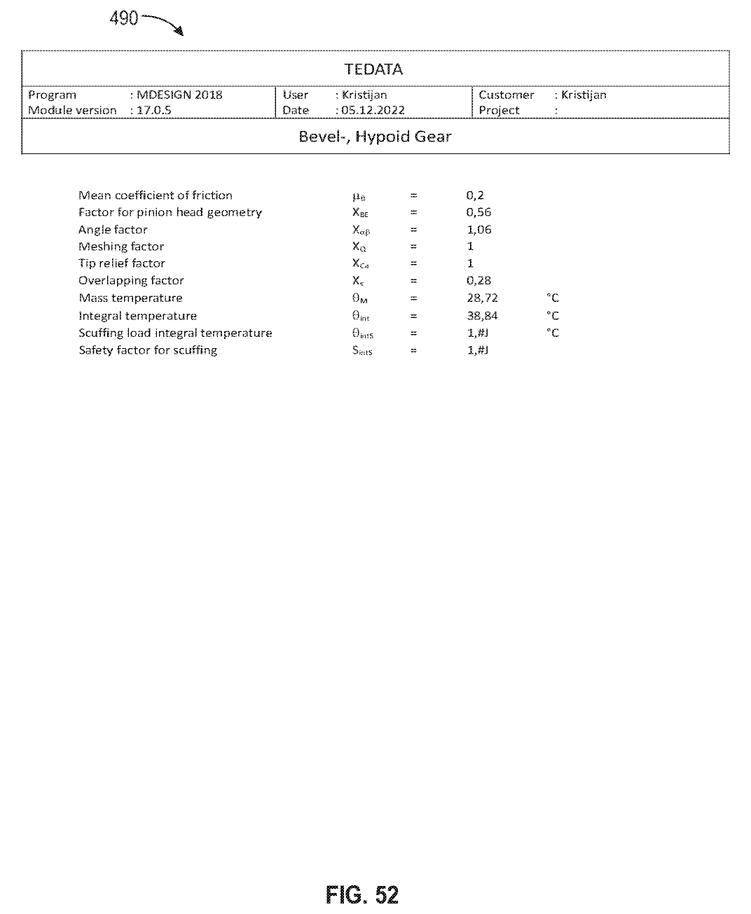

Various features and embodiments of one or more constant micro power energy systems and devices (hereinafter system 5 or “CMPES” device 10”) are explained in conjunction with the description of FIGS. 1A-52.

FIGS. 1A-1B show a perspective view and a side view, respectively of view of a constant micro power energy system (CMPES) 5 which includes an electrical panel 500 and a CMPES device 10, in accordance with one embodiment of the present disclosure. A series of cables 505a-505c is bundled in a cable jacket 510 extend from the CMPES device 10 and are configured to operably couple to the panel 500. It is contemplated that each of these cables 505a-c in the cable jacket 500 is 120 V resulting in a 3-phase connection.

FIG. 2 shows components of CMPES device 10 placed side-by-side, in accordance with one embodiment of the present disclosure. CMPES device 10 includes a main body structure 12. FIG. 3 shows a perspective view of main body structure 12. Main body structure 12 includes a base plate 14 having legs 16. Base plate 14 comes in a circular configuration but may be any geometrical shape, e.g. shaped to improve stability of the device. In one example, main body structure 12 includes four legs 16. Legs 16 connect to base plate 14 using known mechanisms such as welding, fastener, etc. The welded connection ensures a strong and reliable connection between legs 16 and base plate 14 enabling CMPES device 10 to withstand external forces and vibrations.

FIG. 4 shows a perspective view of leg 16, in accordance with one embodiment of the present disclosure. Leg 16 includes a leg base 18. Leg base 18 comes in a relatively flat configuration. Leg base 18 includes one or more leg holes 20 defined therein. One leg hole 20 helps to anchor CMPES device 10 to the floor using an anchor screw (not shown) in order to ensure stability during operation. Other types of anchor systems are envisioned. Another leg hole 21 defined in leg base 18 may be configured to help to level CMPES device 10 in order to achieve optimal balance and alignment. Leg 16 includes a leg column 22 extending from leg base 18. In one example, leg 16 has a support member 24 that is welded to leg base 18 and leg column 22. Support member 24 provides additional support to retain leg base 18 and leg column 22 in position. Further, leg 16 may include a leg connecting plate 26. Leg connecting plate 26 is positioned above leg column 22 and connects to base plate 14. Leg connecting plate 26 has holes 28 defined therein for engaging fasteners (not shown) in order to connect to base plate 14. Legs 16 are designed to securely anchor CMPES device 10 to the floor or other structure and adjust for proper leveling of device 10. Legs 16 enhance the overall stability and performance of CMPES device 10 ensuring its efficient operation in various environments.

Main body 12 has a frame 29 extending upwards from base 14. Main body 12 includes a top plate 30, as shown in FIG. 3. In one example, top plate 30 is fabricated from a durable steel material and undergoes pre-machining processes prior to assembly. Other materials are contemplated. Top plate 30 has a circular rim 31 having a plurality of arms 32. FIG. 5 shows a bottom perspective view of top plate 30. As can be seen, arms 32 extend from circular rim 31. Each arm 32 includes a motor receiving section 34 defined therein. Top plate 30 mounts at the top of a flask barrel 40 (FIG. 2). Top plate 30 mounts at the top of flask barrel 40 in a centered position and helps to connect a ring gear 70 and a plurality of geared motors 44.

In order to connect top plate 30 to flask barrel 40, top plate 30 is fastened using screws, e.g. socket screws (not shown) or any other type of fastening mechanism. The screws ensure a robust and reliable attachment between top plate 30 and flask barrel 40 providing structural integrity to the overall assembly of CMPES device 10. This helps to reduce vibration and promotes system stability. In addition to the screw fastening, after the assembly process and tightening of the screws, a plurality of dowel pins 46 may be press-fitted into position between top plate 30 and the main welded structure. FIG. 6 shows dowel pins 46 used to press-fit top plate 30 to frame 29.

Further, FIG. 7 shows an enlarged view of dowel pins 46 press-fitted into position between top plate 30 and the main welded structure. Dowel pins 46 also enhance the stability of top plate 30 and prevent any potential twisting or rotational torque on the screws particularly when subjected to excessive forces, e.g., torque, from motors 44. This additional measure of the dowel pins 46 reinforces the structural integrity and reliability of CMPES device 10 during operation.

In one implementation, a suitable surface protection treatment is applied on CMPES device 10 to protect the entire structure against corrosion and to ensure its long-term durability. The corrosion-resistant coating safeguards the CMPES device 10 from environmental factors and extends its operational lifespan. The constructional features of top plate 30, fasteners, and dowel pins 46, allows the CMPES device 10 to be robust and secure in assembly. The surface protection against corrosion further enhances longevity, ensuring reliable performance over an extended time period. Various environmental and corrosion resistant coating are envisioned and are typically dependent on a particular purpose or a particular environment.

FIG. 8 shows a front view of flask barrel 40, in accordance with one embodiment of the present disclosure. Flask barrel 40 includes a cylindrical member 48 having an opening 50 defined at the top thereof. The height of the flask barrel 40 may vary. In one example, flask barrel 40 is constructed using three high-grade aluminum parts or other suitable materials joined together through Tungsten Inert Gas (TIG) welding. Other fastening methods are envisioned. Once the welding process is complete, flask barrel 40 undergoes precision machining to achieve desired geometrical dimensions and specified tolerances.

In one example, flask barrel 40 includes a flask cap 52 secured onto the flask barrel 40 and configured to ensure the integrity of the internal lubrication area encompassing two bearings (not shown). Flask barrel 40 also includes one or more flask rings 54 mounted about the cylindrical member 48, as can be seen in FIG. 8. In one example, cylindrical member 48 may include holes 56 defined therein. Flask ring 54 provides a mounting surface for the CMPES device 10 and offers additional support for ring gear 70. Flask ring 54 may be manufactured integrally with cylindrical member 48. A bottom 53 of the flask barrel 40 is secured to base a support rod 63 about one or more bearings 64 to ensure stable rotation of thereof within the body structure 12.

An additional welded ring 58 is positioned at the topmost point of the inside of flask barrel 40, as shown in FIG. 11. Welded ring 58 provides support for a second flask barrel 40’ (FIG. 9) and acts as an assembly surface ensuring geometric concentricity of the flask barrels 40 and 40’ while also offering suitable points for secure fastening of the second flask barrel 40’.

Flask barrel 40 includes a shaft 60 that is configured to securely engaged a middle section of flask barrel 40 (40’) (via screw-like engagement or other engagement known in the art). FIG. 10 shows a perspective view of shaft 60, in accordance with one embodiment of the present disclosure. Shaft 60 undergoes precision machining processes to attain the desired geometry, tolerances, and concentricity. When assembling multiple flask barrels 40 and 40’ atop one another, a coupling shaft 60’ can be used to mechanically engage the shafts 60 disposed within each flask barrel 40 and 40’.

FIGS. 11 and 12 show cross-sectional views of flask barrel 40 having shaft 60. Further, shaft 60 includes two tapered roller bearings 64, strategically positioned at a specific distance from each other which are configured to allow barrel 40 to rotate around the flask barrel support rod 63. FIG. 12 shows the feature of roller bearings 64 connected at shaft 60. Roller bearings 64 play a crucial role in ensuring smooth rotational movement of shaft 60. To secure roller bearings 64 axially, a KM nut 66 is employed on the top side of shaft 60, effectively preventing any unintended displacement. To protect the interior of roller bearings 64 from external debris and contamination, a seal 68 is positioned at the bottom of shaft 60. Seal 68 acts as a barrier, safeguarding the bearing housing from potential contaminants that could adversely affect its service life. Additionally, seal 68 serves to prevent grease leakage from the internal side of the bearing housing, maintaining proper lubrication and operational efficiency. The inclusion of tapered roller bearings 64, along with the utilization of KM nut 66 and a reliable seal 68 enhances the overall performance and longevity of the shaft 60. The components work in harmony to ensure the smooth and efficient rotation of shaft 60 while effectively preventing the ingress of harmful contaminants.

Further, flask barrel 40 includes the ring gear 70. FIG. 13 shows a perspective view of the ring gear 70, in accordance with one embodiment of the present disclosure. Ring gear 70 attaches to flask barrel 40 at the top via operative engagement thereof and spaced relative to the shaft 60 (FIG. 17). Further, ring gear 70 connects to a motor gear 80 operably coupled to motor 44 and enables rotation of the flask barrel 40 while simultaneously increasing torque output. In one example, ring gear 70 includes helically-shaped teeth disposed about an outer diameter thereof. Along the normal teeth surface, ring gear 70 includes, holes 71, for example, ten (10) evenly spaced threaded holes, to facilitate the assembly of ring gear 70 to the barrel 40 assembly of shaft 60. The threaded holes ensure a robust and reliable connection between ring gear 70 and the rest of the system. FIG. 14 shows a cross-sectional view of flask barrel 40 having ring gear 70 assembled to shaft 60.

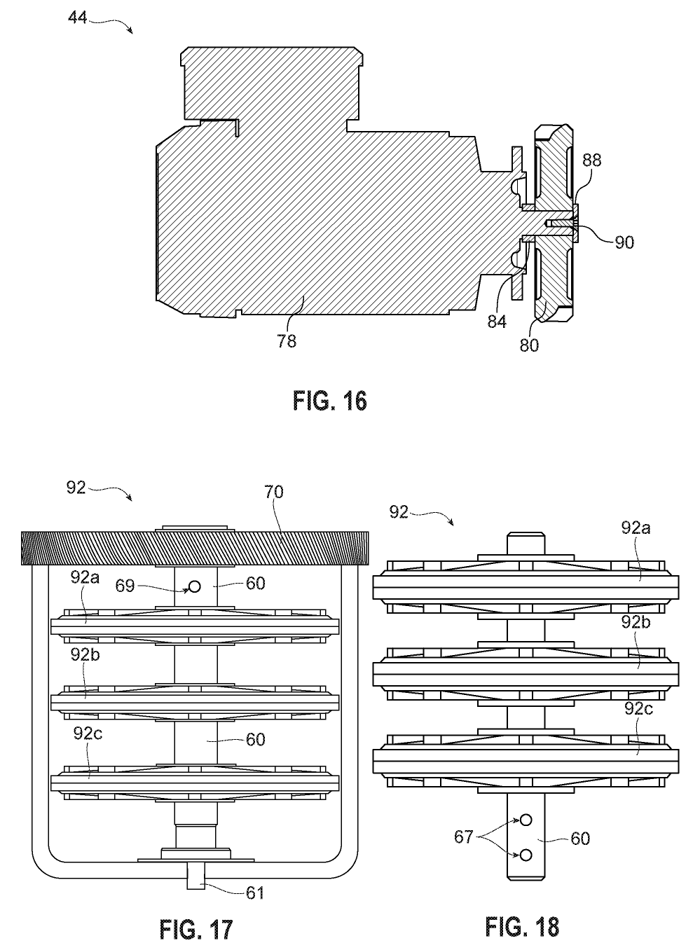

As mentioned above, CMPES device 10 includes motor 44 shown in FIGS. 15 and 16 shown as respective perspective and cross-sectional views. In accordance with one embodiment of the present disclosure, CMPES device 10 includes six (6) motors 44, each motor 44 designed to connect to top plate 30 at motor receiving section 34 (See FIGS. 1A and 6). Each motor 44 includes a motor housing 78 that operably supports a helical gear (motor gear) 80 having a plurality of teeth. In one embodiment, each individual motor 44 is capable of delivering a power output of about 0.75 kW along with a nominal output torque of 4.95 Nm and a peak torque of 12.7 Nm. Numerous other motors 44 having various power outputs and torques are envisioned depending on the need or scale of the present disclosure and the present example is not meant to be limiting.

Motors 44 are meshed with the main barrel gear 70, which is operably and securely connected to the central flask barrel 40. This configuration ensures effective power transmission throughout the system 5. For example, in one embodiment, when the total mass of the system 5 is about 720 kg, a rotational speed is recommended to achieve operational efficiency of the system 5, e.g., approximately 250 rotations per minute (rpm). Three (3) 0.75 kW motors 44 may be utilized to rotate the barrel 40 at this speed. In the above-identified embodiment, an additional three (3) 0.75 kW motors 44 may be activated in any alternating manner to reach or maintain the recommended rotational speed. Other systems with other larger or smaller scalable components and designs are contemplated having other specifications for recommended rotational speeds.

The use of six (6) motors 44 allows for mechanical or electrical switching features to provide alternate or alternating power of each motor 44, e.g., three (3) motors 44 are in use (active state) while the other three (3) motors 44 are in a resting or inactive state. The switching can occur at any time interval depending upon a particular purpose. It is contemplated that the rotational power distribution ensures efficient operation and prevents excessive strain on any individual motor 44.

To enhance a smooth and secure connection, each motor gear 80 includes helical teeth 82, a design known to enhance efficiency and performance. Other teeth configurations are contemplated. Motor gear 80 is directly mounted on a main motor rotor shaft 84 and axially secured using a keyway 86 (or other type of securing connection)n, a cap 88, and a socket screw 90. Other methods of mounting the gear 80 are contemplated.

CMPES device 10 includes one or more disc flux generators 92. FIGS. 17 and 18 show a plurality of disc flux generators (or disc generators) 92a-92c in perspective view mounted atop a disc shaft 61 in accordance with one embodiment of the present disclosure. In embodiments, shafts 60 and 61 may be integral or assembled concentrically within one another and coupled by one or more pins. Disc flux generators 92a-92c are positioned inside flask barrel 40 whereby each disc flux generator, e.g., disc flux generator 92a, is designed to produce a specified kilowatt output based on rotation thereof. In embodiments, disc flux generators 92a-92c may be constructed using high-quality aluminum parts that are welded together. Other parts of the disc generator 92a may be integrally-formed or assembled.

Disc flux generators 92a-92c are concentrically mounted inside the flask barrel 40 at the top and bottom of shaft 60 of the flask barrel 40 via one or more mechanically engaging features, e.g., screw 69 and thread 67, ensuring the flux generators 92a-92c are secured, centered, stable and balanced within the flask barrel 40. The flask barrel 40 and the flux generators 92a-92c are configured to move in unison once assembled about the support rod 63. This configuration allows for efficient power generation and facilitates the proper alignment and functioning of the disc generators 92a-92c. By placing disc flux generators 92a-92c inside flask barrel 40, the overall structural integrity and stability of CMPES device 10 is maintained, ensuring reliable and consistent electricity production.

It is envisioned that as long as the flux generators 92a-92c are balanced and rotationally stable, the flux generators 92a-92c may vary in size. For example, in one implementation, the design of disc flux generators 92a-92c may incorporate a larger-sized disc flux generator (similar to flux generators 92a-92c) mounted towards the bottom of flask barrel 40 in order to deliver higher kilowatt output. In other words, disc flux generators 92a-92c are optimized for increased power generation. The construction of these larger-sized disc flux generators (not shown) may involve utilizing high-quality materials and advanced manufacturing techniques. By strategically placing the larger disc flux generator at the bottom of flask barrel 40, the design ensures efficient utilization of available space and maximizes power output. The configuration also allows for enhanced energy conversion and improved overall performance of the device.

For example, the larger-sized disc flux generators (similar to flux generators 92a-92c) contribute to a significant increase in kilowatt output, making the CMPES device 10 capable of generating higher levels of electricity. Larger-sized disc flux generators 92a-92c (and, if warranted, larger flask barrels 40) enhance the CMPES device’s 10 potential for meeting the different energy demands of various applications, including those requiring a substantial power supply or, in some cases, smaller power supply (microelectronics for example). Incorporating these differently-sized disc flux generators (not shown) may provide a reliable and efficient solution for generating different wattage output (Gigawatt (or higher), Megawatt, Kilowatt, watt, microwatt, nanowatt (or lower)), addressing the needs of a wider range of power requirements.

FIG. 19 shows a cross-section of CMPES device 10, specifically the area motor 44 and its gear mesh with ring gear 70 connected. Ring gear 70 along with a protective cover or sheet 94 operably connected to the outside are securely engaged to flask barrel 40. Additionally, the partial sectional view showcases three (3) assembled flask barrels 40 on the interior (located on the right side of the section view). In order to mount motor 44s, a first motor 44 is positioned from the bottom side of top plate 30 (FIGS. 5-7) and secured in place using bolts 46 or the like. A distance ring is then placed on top of main motor rotor shaft 84, followed by the pinion gear 80. To prevent torsion, a keyway may be added to the main motor rotor shaft 84 (FIG. 16). Axially, gear 80 is secured using a cap 88 and a cone socket bolt 90. Next, ring gear 70 is assembled onto flask barrel 40 (FIG. 17). In one example, screws are used to firmly bolt the ring gear 70 in place or the ring gear 70 may be secured in any known fashion in the art. To ensure stability and prevent twisting of the screws, dowel pins 96 may be added to secure ring gear 70, as shown in FIG. 20. This construction design ensures a secure and reliable connection between motor 44, gear 80, and ring gear 70, maintaining the integrity and functionality of CMPES device 10.

Further, CMPES device 10 may include one or more protective fences 98, as shown in FIG. 21. In one embodiment, protective fence 98 is installed over the top of the assembly of the CMPES device 10, encompassing the pinion gear 80 and ring gear 70. Protective fence 98 may be constructed from perforated sheet metal steel, which is may be laser-cut to create the mesh-like pattern. On the bottom side of the sheet, a vertical ring may be point welded, adding further reinforcement. Protective fence 98 is contemplated to feature multiple holes defined therein that facilitate assembly to the main top plate 30 of the assembled device 10. These holes may serve as attachment points for securing a protective mesh (not shown) in place. To guard against corrosion, protective fence 98 may be treated with a corrosion-resistant paint coating. Protective fence 98 effectively safeguards the assembly, ensuring the longevity and durability of the device by preventing unwanted contact or interference with the pinion gear and ring gear.

FIG. 22 shows protective fence 98 strategically positioned using one or more distance rings 100 that are situated in close proximity to the electrical motors 44. Rings 100 ensure that protective fence 98 is set at a safe distance from both the motor drive gear 80 and the machine ring gear 70. The arrangement ensures that there is ample space, reducing the possibility of tools or hands coming into contact with the rotating gears 80, 70 while the CMPES device 10 is in operation. It is contemplated that the inclusion of distance rings 100 mitigates unwanted interactions with the moving parts of CMPES device 10.

CMPES device 10 may include one or more decorative panels 102 as shown in FIG. 23 in accordance with one embodiment of the present disclosure. Decorative panels 102 may be configured to conceal and protect the bottom side of the CMPES device 10. In one example, two half-circle sheet metal decorative panels 102 are used to cover the bottom side of the main frame 12 of the CMPES device 10. The decorative panels 102 may be precisely bent to match the diameter of the main frame 12 of the device 10. To ensure a secure fit, these two decorative panels 102 are operably coupled to the main frame 12 which ensures a neat and seamless appearance while providing structural integrity and stability to the machine.

FIGS. 24 and 25 show a perspective view and a cross-sectional view, respectively, of a cover cap 104, in accordance with one embodiment of the present disclosure. Cover cap 104 may be constructed using plastic and have any geometric shape, e.g., a dome-like shape 106. Cover cap 104 is designed to be operably inserted into flask barrel 40, e.g., by applying pressure from the top until it is securely engaged to flask barrel 40. To facilitate ease of use, cover cap 106 features a small flange-like geometry 108 around the periphery thereof, providing ample grip for opening or closing the upper section of the CMPES device 10. The design ensures convenient access to the internal components while maintaining a secure and enclosed environment.

Now referring to FIGS. 26 - 52, operation of CMPES device 10 is explained, in accordance with one exemplary embodiment of the present disclosure. As specified above, the CMPES device 10 includes a plurality, e.g., three (3), disc flux generators 92a-92c, positioned inside flask barrel 40. When the flux generators 92a-92c reach a constant rotation, e.g., reaching a peak or full rotational speed of about 250 rpm (or the necessary rotating speed to generate a desired wattage within a desired time limit (e.g., about 3 to about 60 seconds)), the flux generators 92a-92c produce a continuous power output. In one embodiment, three (3) motors 44 (or three (3) motors of the combined six (6) motors powered at alternating times – See FIG. 1A), each capable of delivering about 0.75 kW power and a combined power output of about 2.25 kW to rotate flask barrel 40 at a constantly speed. The three (3) motors 44 may be initially powered by a power source until constant rotational speed is achieved and then powered directly or indirectly from the power generated by disc flux generators 92a-92c. The majority of the power generated by the flux generators 92a-92c is communicated to one or more electrical panel systems 500 connected to CMPES device 10 (FIG. 1B).

FIG. 26 shows a circuit diagram 150 of a 3-phase electric supply originating from disc flux generators 92a-92c to the one or more electrical panel systems 500. Circuit diagram 150 includes three power sources (3-phase power sources of 15 kW) 152, 154, 156 connected to Variable Frequency Drives (VFD) 176, 178, 180, 182, 184, 186 via circuit breakers 158, 160, 162, 164, 166, 168, 170, 172, 174. VFDs 176, 178, 180, 182, 184, 186 connect to the six motors 44 (44a-44f). Here, each motor 44 delivers a power output of about 0.75 kW to initiate rotation of the flask barrel 40. As specified above, cylinder flask barrel 40 at full rotational speed produces enough speed for disc flux generators 92a-92c to produce output power to the one or more electrical panel systems 500 of tens or hundreds of kilowatts or more.

Once the axial-flux disc generators 92a–92c reach nominal rotation, they produce 3-phase AC power 152, 154, 156 which is routed to the one or more electrical panel systems 500. The motors 44 may remain under variable frequency drive control (VFD) control to maintain synchronous operation and speed regulation.

For example, when disc flux generators 92a-92c are arranged in combinations of 5 kW - 100 kW, the disc flux generators 92a-92c are capable of providing power output kilowatts at about 85% efficiency of the total sum of the predicted power output of each disc flux generators 92a-92c as the flask barrel 40 holds and rotates constantly at a specified rotational speed, e.g., about 250 rpm, or any other desired speed. The rotational output from rotating flask barrel 40 feeds the disc flux generators 92a-92c as they conjointly rotate to provide 3-phase output power to the one or more electrical panel systems 500 and, in embodiments, provides continuous power to motors 44.

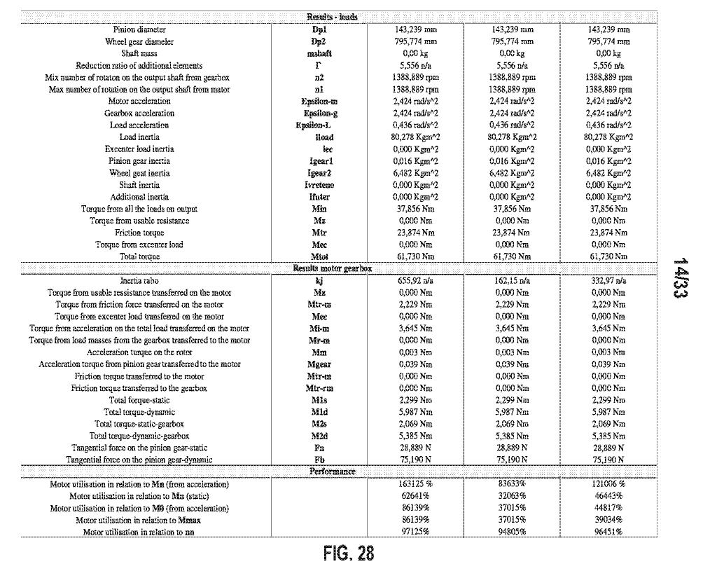

FIGS. 27 and 28 show tables 200, 210 presenting initiation calculations and selection of motors 44 in accordance with the one contemplated embodiment utilizing three (3) 0.75 kW motors 44. The motor 44 selection process is dependent on several desired input and output requirements, system 5 size parameters, system 5 weight and mass parameters, barrel 44 rotational requirements, barrel 44 acceleration requirements, etc. For example, an approximated load mass of 600 kg from disc flux generators 92a-92c, a maximum rotation speed of the flask barrel 40 of 250 rpm, and a preference for low motor 44 power output, results in a power requirement of about 0.5 kW per motor 44 utilizing three (3) motors. The initial flask barrel 40 geometry may also be a contributing factor with motor 44 selection, with the above identified parameters, a diameter of about 750 mm is recommended for the barrel 44 however, any diameter is contemplated. Utilizing one or any plurality of motors 44, e.g., at least two motors 44, is contemplated to improve the efficiency and operation of the CMPES device 10. The CMPES device’s 10 kinematics and dynamics may also be a contributing factor to enhancing output, safety, and acceleration time. In the given example incorporating a 20% safety margin, an acceleration time of approximately 60 seconds and an added mass of 720 kg is obtained.

In embodiments, incorporating a gearbox is considered in order to reduce the motor 44 size and meet suitable design requirements. A gear assembly (not shown) may be used to offset the driving forces applied to the ring gear 70. Pinion gear 80 designed with an optimized number of teeth may be included and configured to improve efficiency of the torque transfer from the pinion gear 80 to the ring gear 70 as explained in more detail below. Rolling bearings 64 (FIG. 12) may be included to reduce friction between rotating components reducing the relative friction therebetween, e.g., a friction coefficient of 0.01 is assumed with table calculations below. The system's 5 preload is accounted for and set at about 30% of the total load. The exemplary calculations were conducted considering the use of three (3) motors 44.

From an initial calculation for optimizing motor selection for a particular purpose, it is observed that motors 44 with a power output of 1.1 kW provides a suitable solution, even for a load of 720 kg with the disc flux generators 92a-92c and flask barrel 40. However, it is contemplated that configuring the system 5 with one or motors 44 with less than 1 kW power output may be more advantageous. For example, motors 44 with 1.1 kW power output may be slightly over-dimensioned for a 720 kg load, e.g., shown to operate at 83% capacity during the initial acceleration stage and 32% during nominal operation time. As such, the initial pinion drive gear 80 with a module of five (i.e., ratio of gear pitch diameter to number of teeth) includes twenty-seven teeth, and a pitch diameter of about 143 resulted in a transmission ratio (i) of 5.556 indicating that from the motors’ 44 initial speed of 1465 rpm, the rotational speed is reduced to 263 rpm.

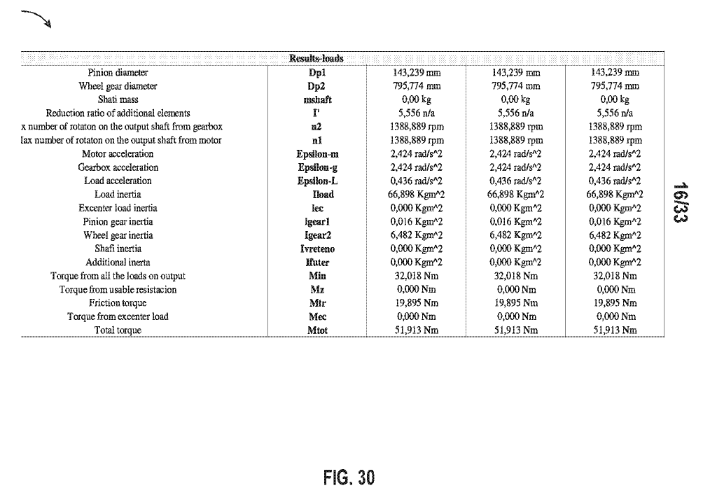

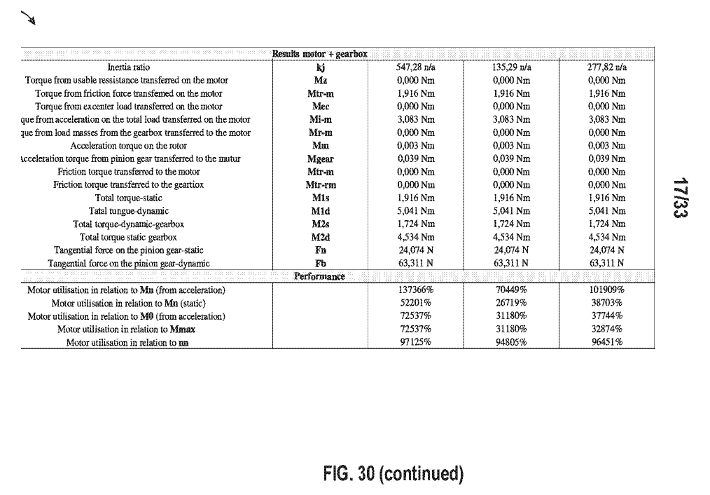

In another embodiment using a lower mass of 600 kg with a full rotational speed of 250 rpm, using the same drive pinion gear 80 and a transmission ratio of i=5.556, the results obtained (See tables 220, 230 of FIGS. 29 and 30, respectively) show a lower power requirement of 0.75kW for each motor 44 with a speed requirement of 1440 rpm and a torque of 4.95 Nm which indicates a more suitable motor 44 candidate. This motor(s) 44 demonstrated very good utilization, with 100% or more of the motor’s 44 acceleration torque being utilized during the initial starting acceleration phase. Testing may be conducted to determine the best candidate for a given design requirement.

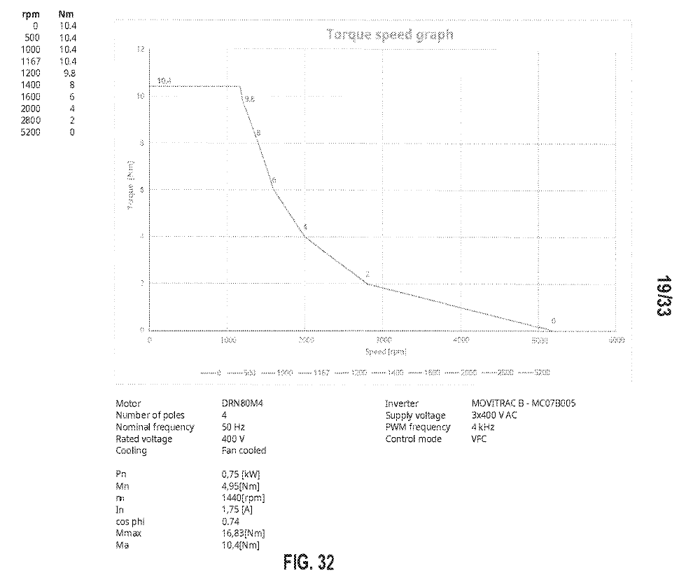

In one embodiment in accordance with the present disclosure, after continued testing, a particularly well-suited motor for the system 5 was the SEW IE3 DRN80M4 motor sold by SEW Eurodrive. The characteristics of this particular motor 44, e.g., torque speed graph 240 and peak torque graph 250 are shown in FIGS. 31 and 32, respectively.

Referring to FIG. 33, a table 260 is shown including input data and profile design data for exemplary gears (ring gear 70 and drive gear 80) for use with device 10. Based on the initial preliminary kinematic and dynamic calculation of the three (3) motor(s) 44, the basic sizes for the pinion 80 and ring gear 70 may be determined. To further refine the design of these gears, 70 and 80, calculations may be performed using the MDESIGN^{TM} software, which is specifically used for dimensioning mechanical components and elements, e.g., gears. The calculation is performed based on the guidelines provided by the DIN 3990 standard (German Institute for Standardization). An example of the input data needed for calculating the gear teeth, including the profile, tip root diameter, and reference diameter, is illustrated in FIG. 33. This figure shows the various parameters needed to ensure accurate sizing and performance of both the pinion drive gear 80 and the driven ring gear 70.

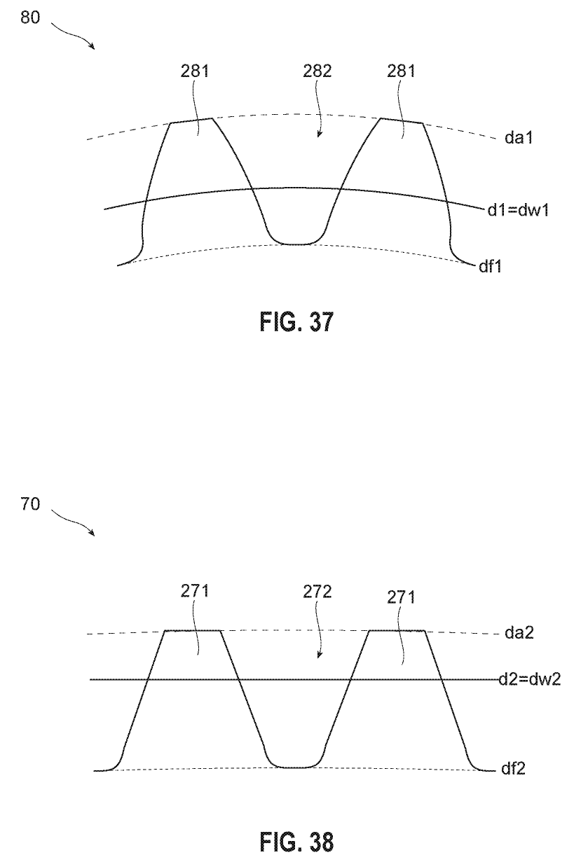

Based on the initial input data of FIG. 33, output calculations and design parameters of the gears 70, 80 are presented in the table 270 shown in FIG. 34. Further, a recommended profile (evolvent) of each tooth 281 of pinion drive gear 80 is shown in FIG. 35 and a recommended profile (evolvent) of each tooth 271 of ring gear 70 is shown in FIG. 36. In addition, the gap 282 defined between respective teeth 281 (envelope curve, evolvent) of pinion 80 is shown in FIG. 37 and the gap 272 defined between respective teeth 271 (envelope curve, evolvent) of ring gear 70 is shown in FIG. 38.

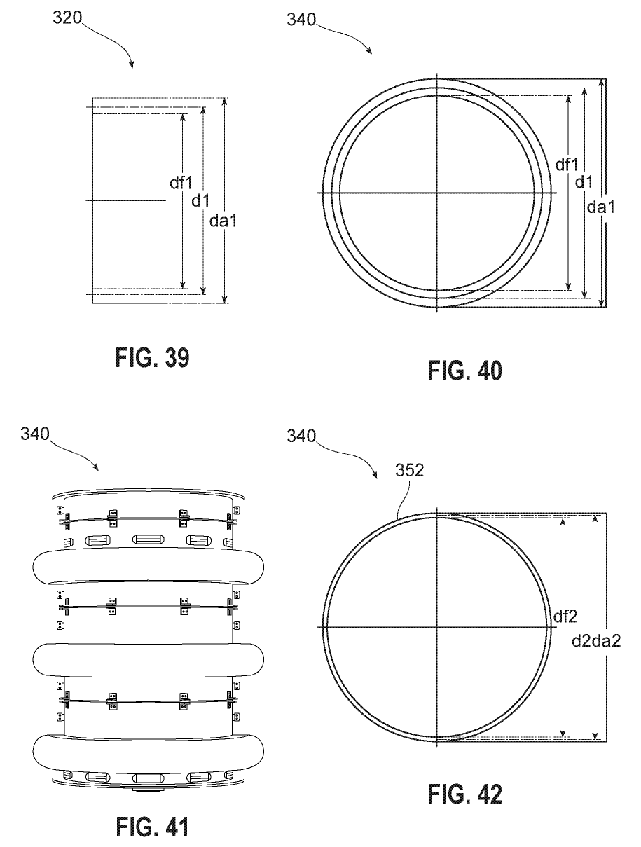

FIG. 39 shows a side view of ring gear 70 and FIG. 40 shows a top view of ring gear 70. FIG. 41 is a view of the flask barrel 40 and FIG. 42 shows a top view of rim 52 of flask barrel 40.

FIG. 43 shows a circuit diagram 360 of 3-phase electric supply originating from disc flux generators 92a-92c to electrical panel systems 500. Circuit diagram 360 includes a single power source (3-phase power source of 5 kW) 362 connected to Variable Frequency Drives (VFD) 372, 374, 376 via circuit breakers 364, 366, 368, 370. Further, VFDs 372, 374, 376 connect to motors 44 (44a-44c). Again, each motor 44 is configured to deliver a power output 0.75kW. As specified above, at full rotational speed (e.g., 250 rpm), cylinder flask barrel 40 produces enough speed for disc flux generators 92a-92c to produce output power up to hundreds of kilowatts (depending on the size of each flux generator 92a-92c) from significantly lower motor 44 power supplies.

In one contemplated embodiment, the disc flux generators 92a-92c are arranged, e.g., stacked, in combinations of 5 kW - 100 kW. The disc flux generators 92a-92c may be arranged to provide a total of output kilowatts at about 85% efficiency in total sum of anticipated output power of the disc flux generators 92a-92c at constant rotation of the flask barrel 40 (e.g., 250 rpm or other designed rpm) from three (3) 0.75kw motors. The power output from disc flux generators 92a-92 via rotation of the flask barrel 40 is also contemplated to provide continuous power to motors 44 which, in turn, continue to assist in rotation of the flask barrel 40 at the necessary speed.

In one envisioned embodiment, the CMPES device utilizes a hand crank handle system 405 for initiating a motor, e.g., a motor 344. FIG. 44 shows a cross-sectional view of a CMPES device 390 utilizing the hand crank handle system 405. CMPES device 390 includes an outer shell 392 encompassing a cylindrical flask barrel 340 . Flask barrel 340 includes a bevel gear 396 disposed on an outer periphery thereof. The bottom of flask barrel 340 includes a mixing material 398. Flask barrel 340 also includes a mounting shaft 400 having bearings 402 at the top and bottom thereof. Hand crank handle system 405 includes a complementary beveled pinion gear 404 configured to engage bevel gear 396. Bevel pinion gear 404, in turn, connects to a bearing sleeve 406, which, in turn, connects to a handle 408 and handle lever 410 of the hand crank handle system 405.

Hand crank handle system 405 uses handle 408 to produce initiation, power, and output for a plurality of motors 344 . The hand crank system 405 eliminates the need for a reliance on battery storage or grid power to initiate rotation of the flask barrel 240 of the device 390. In one embodiment, the hand crank device system 405 utilizes specific components and component ratios, e.g., gears, cylinder size (375 mm diameter) as shown Table 420 of FIG. 45. Hand crank device system 405 helps the flask barrel 340 to reach 150 rpm for a 150 kg cylinder containing one 5 kW disc flux generator, e.g., disk flux generator 393. Rotation by hand can be utilized to reach the required 150 rpm for the 5 kW disc flux generator 393, in an acceptable time period with little-to-moderate effort, e.g., about 1 to 5 minutes. At full rotation, the flask barrel 340 and the disc flux generator 393 output 2.25 kW from motor 344 requiring a power of 0.75 kW. A transfer switch 475 is included to take over rotation of the flask barrel 340 once the appropriate power is being supplied to motor 344 the power. Motor 344 maintains the rotation of the flask 340 which provided energy to a panel (e.g., panel 500) or system (not shown).

Calculations for envisioned gears, e.g., pinion 404 and bevel gear 396, (bevel and hypoid gear for 5 kW cylinder barrel 340) are shown in Tables 420, 430, 440, 450, 460, 470, 480 and 490 presented in FIGS. 46 – 52, respectively.

The present disclosure also relates to one or more methods of generating electrical power. More particularly, one envisioned method includes: mechanically coupling one or more electric motors 44 to a rotating assembly including a shaft 63, a flask barrel 40 configured to provide rotational inertia, and one or more disc-flux electrical generators 92a-92c; initiating rotation of the rotation assembly until the rotating assembly reaches a predetermined consistent rotational speed generating continuous and simultaneous alternating current (AC) and direct current (DC) as an electrical power output; and providing the electrical power output to electrical panel systems 500 adapted to connect to the CMPES device 10. In embodiments, the sum of electrical power output from the rotation of the disc flux generators 92a-92c is greater than a sum of electrical power input powering the one or more motors 44.

In embodiments, the method may include supplying electrical input to the one or more electric motors 44 to initiate rotation of the rotating assembly and offloading the electrical input once the rotation assembly reached the predetermined consistent rotational speed.

In embodiments, the method may include increasing rotational velocity of the rotating assembly such that the barrel 40 accumulates rotational kinetic energy.

In embodiments, the method may include generating electrical output from the one or more disc-flux electrical generators 92a-92c as a function of sustained rotational motion of the rotating assembly.

In embodiments, the method may include stabilizing rotation of the rotation assembly after reaching a threshold rotational velocity. In other embodiments, the method may include reducing the incremental torque demand on the rotation assembly upon initial rotation of the rotation assembly by stabilizing the rotation thereof.

The presently disclosed CMPES devices, e.g., device 10, provides several advantages over the prior art. The CMPES device 10 utilizes multiple disc flux generators 92a-92c arranged in a cylindrical shape and constantly powered for rotation using low-wattage motors 44. The inclusion of disc flux generators 92a-92c is particularly advantageous due to their proven high efficiency and minimal maintenance requirements. The overall system 5 may be optimized to be cost-effective in terms of manufacturing, installation, and maintenance, ensuring accessibility to a wide range of applications and users. By addressing the shortcomings of traditional renewable energy technologies, the CMPES device 10 generates a consistent and constant power supply that is not dependent on weather conditions. The CMPES device 10 eliminates the need for a separate storage system, streamlining the overall energy generation process.

By circumventing the existing obstacles associated with renewable energy devices, this disclosure presents a distinctive and invaluable contribution to the ongoing transition toward sustainable energy generation. The CMPES device 10 potential lies in its ability to establish a more efficient and reliable renewable energy system, ushering in a new era of sustainable power generation.

A person skilled in the art may appreciate that the CMPES device 10 can come in a variety of shapes and sizes depending on the need. Further, many changes in the design and placement of components may take place without deviating from the scope of the presently disclosed CMPES device 10 as described herein. For example, large scale devices may be designed and manufactured using the concepts described here in to produce outputs in the Megawatt or Gigawatt range. Further, the device 10 may be scaled down to have the aforedescribed component features measured in micrometers or nanometers to produce wattages for micro electronic devices (MEMS) or nano electronic devices (NEMS).

In the above description, numerous specific details are set forth such as examples of some embodiments, specific components, devices, methods, in order to provide a thorough understanding of embodiments of the present disclosure. It will be apparent to a person of ordinary skill in the art that these specific details need not be employed, and should not be construed to limit the scope of the disclosure.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the disclosure, it is intended that all matter contained in the above description or shown in the accompanying drawings shall be interpreted as illustrative and not in a limiting sense.

The foregoing description of embodiments is provided to enable any person skilled in the art to make and use the disclosure. Various modifications to these embodiments will be readily apparent to those skilled in the art, and the novel principles and disclosure disclosed herein may be applied to other embodiments without the use of the innovative faculty. It is contemplated that additional embodiments are within the spirit and true scope of the disclosed disclosure.

What is claimed:

1. A device for a constant micro power energy system (CMPES), comprising:
a main body structure including a base plate, a frame extending from the base plate, and a top plate positioned at the top of the frame;
a flask barrel positioned within the frame;
one or more motors operably mounted to the top plate, the one or more motors operably connected to an electrical power input for powering each of the one or more motors, each motor of the one or more motors including a motor shaft having a gear configured for rotation with the motor shaft;
a ring gear operatively coupled to the flask barrel and engaged with each gear of each of the one or more motor shafts;
one or more disc flux generators positioned inside the flask barrel and configured to rotate with the flask barrel,
wherein each shaft of the one or more motors is configured to rotate each respective gear upon actuation of each of the one or more motors, which, in turn, is configured to rotate the ring gear and drive rotation of the flask barrel and the one or more disc flux generators up to a predetermined consistent rotational speed,
wherein rotation of the flask barrel and the one or more disc flux generators at a predetermined consistent rotational speed generates continuous and simultaneous alternating current (AC) and direct current (DC) electrical power output,
wherein the one or more disc flux generators, in turn, provide the electrical power output to electrical panel systems adapted to connect to the CMPES device, and
wherein a sum of electrical power output from the rotation of the disc flux generators is greater than a sum of electrical power input powering the one or more motors.

2. The CMPES device according to claim 1, wherein the rotation of the flask barrel and the one or more flux generators is also configured to provide electrical power to the one or more motors once the one or more disc flux generators reach the predetermined rotational speed.

3. The CMPES device according to claim 1, wherein the predetermined consistent rotational speed and the predetermined rotational speed are the same.

4. The CMPES device according to claim 1, wherein the sum of the electrical power output of the one or more motors is in the range of about 0.75 kW to about 30 kW.

5. The CMPES device according to claim 1, wherein each of the one or more motors is configured to deliver a power output in the range of about 0.75 kW to about 5 kW.

6. The CMPES device according to claim 5, wherein two or more motors of the one or more motors are configured to be in an active state and remaining motors of the one or more motors are configured to be in a resting state, and wherein the two or more motors of the one or more motors in the active state deliver a combined electrical power output is in the range of about 1.5 kW to about 30 kW to rotate the flask barrel and the one or more disc flux generators at a consistent rotation.

7. The CMPES device according to claim 1, wherein the flask barrel rotates at a predetermined consistent rotational speed of about 250 rotations per minute (rpm).

8. The CMPES device according to claim 1, wherein the one or more disc flux generators are stacked inside the flask barrel such that a larger-sized disc flux generator of the one or more disc flux generators is positioned at the bottom of the flask barrel and is configured to deliver a higher kilowatt output.

9. The CMPES device according to claim 1, wherein the position of the one or more disc flux generators is adjustable within the flask barrel.

10. The CMPES device of claim 1, further comprises decorative panels, wherein said decorative panels encapsulate the bottom side of said main body structure.

11. The CMPES device of claim 1, further comprises a cover cap, wherein a cover cap inserts onto said flask barrel and facilitates convenient opening and closing.

12. The CMPES device of claim 1, wherein the one or more disc flux generators are arranged in combination and each disc flux generator is configured to produce an electrical power output in the range of about 5 kW-100 kW.

13. The CMPES device of claim 1, further comprises a protective fence and distance rings, wherein said protective fence positions on said distance rings to provide a safe distance between a motor drive gear of each of said motor and said ring gear in order to prevent accidental contact during operation.

14. The CMPES device of claim 1, further comprising a control system configured to monitor and regulate the electrical power output of the one or more disc flux generators to optimize energy output of the one or more disc flux generators.

15. The CMPES device of claim 1, further comprising a hand crank handle system operably affixed to the flask barrel and configured to manual initiate rotation of the flask barrel and generation of electrical power output from the one or more disc flux generators.

16. A constant micro power energy system (CMPES), comprising:
an electrical power source providing an electrical power input;
a CMPES device including one or more motors operably coupled to the electrical power source and configured to receive the electrical power input;
a main body structure configured to operably support the one or more motors, each motor of the one or more motors including a motor shaft having a gear configured for rotation with the motor shaft;
a flask barrel positioned within the main body structure, the flask barrel including a ring gear operatively coupled to the flask barrel and configured to engage each gear of each of the one or more motor shafts;
one or more disc flux generators positioned inside the flask barrel and configured to rotate with the flask barrel,
wherein each shaft of the one or more motors is configured to rotate each respective gear upon actuation of each of the one or more motors, which, in turn, is configured to rotate the ring gear and drive rotation of the flask barrel and the one or more disc flux generators up to a predetermined consistent rotational speed,
wherein rotation of the flask barrel and the one or more disc flux generators at a predetermined consistent rotational speed generates continuous and simultaneous alternating current (AC) and direct current (DC) electrical power output,
wherein the one or more disc flux generators, in turn, provide the electrical power output to an electrical panel system, and
wherein a sum of the electrical power output from the rotation of the disc flux generators is greater than a sum of the electrical power input powering the one or more motors.

17. The CMPES device according to claim 16, wherein the rotation of the flask barrel and the one or more flux generators is also configured to provide electrical power to the one or more motors once the one or more disc flux generators reach the predetermined rotational speed.

18. The CMPES device according to claim 16, wherein the sum of the electrical power output of the one or more motors is in the range of about 0.75 kW to about 30 kW and each of the one or more motors is configured to deliver a power output in the range of about 0.75 kW to about 5 kW.

19. The CMPES device according to claim 16, wherein two or more motors of the one or more motors are configured to be in an active state and remaining motors of the one or more motors are configured to be in a resting state, and wherein the two or more motors of the one or more motors in the active state deliver a combined electrical power output is in the range of about 1.5 kW to about 30 kW to rotate the flask barrel and the one or more disc flux generators at a consistent rotation.

20. A method for generating energy, comprising:
rotating a flask barrel and one or more flux generators using electrical power input from one or more motors to reach a predetermined consistent rotational speed such that the rotation of the flask barrel and the one or more disc flux generators at the predetermined consistent rotational speed generates continuous and simultaneous alternating current (AC) and direct current (DC) electrical power output; and
offloading the electrical power output to one or more electrical panel systems, wherein a sum of electrical power output from the rotation of the disc flux generators is greater than a sum of electrical power input powering the one or more motors.
